(19) United States
(12) Patent Application Publication
(10) Pub. No.: US 2025/0274972 A1
(43) Pub. Date: Aug. 28, 2025

(54) PREAMBLE PARTITIONING AND MAPPING FOR PUSCH IN RACH WITH OCC

(71) Applicant: QUALCOMM Incorporated, San Diego, CA (US)

(72) Inventors: Syed Hashim Ali SHAH, San Diego, CA (US); Chiranjib SAHA, Lakeside, CA (US); Alberto RICO ALVARINO, San Diego, CA (US)

(21) Appl. No.: 18/589,349

(22) Filed: Feb. 27, 2024

(51) Int. Cl. H04W 74/00; H04W 72/566; H04W 74/0836

(52) U.S. Cl. CPC H04W 74/006; H04W 72/566; H04W 74/0836

(57) ABSTRACT

The apparatus may be a wireless device configured to receive a configuration for a partitioning of a set of RACH resources between a first class of wireless devices supporting OCC for data transmission during a RACH procedure and a second class of wireless devices not supporting OCC for data transmission, transmit, based on the configuration, a preamble associated with the RACH procedure via a first RACH resource in the set of RACH resources that is associated with the first class of wireless devices, and transmit a data transmission associated with the RACH procedure via a second RACH resource in the set of RACH resources selected based on a mapping of the preamble and at least one of a multiplexing order and an OCC index associated with an OCC applied to the data transmission.

### TECHNICAL FIELD

The present disclosure relates generally to communication systems, and more particularly, to a random access procedure for wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a network device configured to transmit, to a user equipment (UE), a configuration for a partitioning of a set of random access channel (RACH) resources between a first class of wireless devices supporting orthogonal cover codes (OCC) for data transmission during a RACH procedure and a second class of wireless devices not supporting OCC for data transmission during the RACH procedure. The apparatus may be configured to receive, based on the configuration, a preamble associated with the RACH procedure via a first RACH resource in the set of RACH resources that is associated with the first class of wireless devices, monitor a second RACH resource in the set of RACH resources for a data transmission associated with the RACH procedure based on the preamble, a multiplexing order, and an OCC index associated with an OCC applied to the data transmission, and transmit, when the data transmission is received based on the monitoring of the second RACH resource, an additional message of the RACH procedure.

In an aspect of the disclosure, a method, a computer-readable medium, and an apparatus are provided. The apparatus may be a wireless device configured to receive a configuration for a partitioning of a set of RACH resources between a first class of wireless devices supporting OCC for data transmission during a RACH procedure and a second class of wireless devices not supporting OCC for data transmission, transmit, based on the configuration, a preamble associated with the RACH procedure via a first RACH resource in the set of RACH resources that is associated with the first class of wireless devices, and transmit a data transmission associated with the RACH procedure via a second RACH resource in the set of RACH resources selected based on a mapping of the preamble and at least one of a multiplexing order and an OCC index associated with an OCC applied to the data transmission.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and UE in an access network.

FIG. 4A is a diagram illustrating elements of a 4-step RACH process in accordance with some aspects of the disclosure.

FIG. 4B is a diagram illustrating elements of a 2-step RACH process in accordance with some aspects of the disclosure.

FIG. 5A is a diagram illustrating a first RACH resource partitioning based on preamble resources in accordance with some aspects of the disclosure.

FIG. 5B is a diagram illustrating a first RACH resource partitioning based on RACH occasions in accordance with some aspects of the disclosure.

FIG. 6A is a diagram illustrating a first mapping of preambles to PUSCH resource units (PRUs) for a data transmission associated with a RACH process in some aspects of the disclosure.

FIG. 6B is a diagram illustrating a second mapping of preambles to PRUs for a data transmission associated with a RACH process using OCC in some aspects of the disclosure.

FIG. 7 is a call flow diagram illustrating the use of OCC for a 2-step RACH process in accordance with some aspects of the disclosure.

FIG. 8 is a call flow diagram illustrating a method of use of OCC for a 4-step RACH process in accordance with some aspects of the disclosure.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an apparatus.

FIG. 15 is a diagram illustrating an example of a hardware implementation for a network entity.

### DETAILED DESCRIPTION

In some aspects of wireless communication, a RACH process may be performed by a plurality of wireless devices. The RACH process may be associated with a (limited) set of RACH resources. As the RACH process, in some aspects, may be initiated by the individual UEs, a RACH process may be subject to collisions that interfere with, or lead to a failure of, the RACH process. Accordingly, methods of decreasing the likelihood of collisions in the RACH process may improve the efficiency of the RACH process.

Various aspects relate generally to approaches for using OCC in association with a RACH process. Some aspects more specifically relate to approaches for preamble partitioning based on OCC for one or more of a 2-step RACH process or a 4-step RACH process, and a preamble to physical uplink shared channel (PUSCH) mapping for a RACH message (e.g., a MsgA or a Msg3) with OCC. In some examples, a network device may be configured to transmit, to a UE, a configuration for a partitioning of a set of RACH resources between a first class of wireless devices supporting OCC for data transmission during a RACH procedure and a second class of wireless devices not supporting OCC for data transmission during the RACH procedure. The network device may be configured to receive, based on the configuration, a preamble associated with the RACH procedure via a first RACH resource in the set of RACH resources that is associated with the first class of wireless devices, monitor a second RACH resource in the set of RACH resources for a data transmission associated with the RACH procedure based on the preamble, a multiplexing order, and an OCC index associated with an OCC applied to the data transmission, and transmit, when the data transmission is received based on the monitoring of the second RACH resource, an additional message of the RACH procedure. In an aspect of the disclosure, a method, a computer-readable medium, and an apparatus are provided. In some examples, a wireless device may be configured to receive a configuration for a partitioning of a set of RACH resources between a first class of wireless devices supporting OCC for data transmission during a RACH procedure and a second class of wireless devices not supporting OCC for data transmission, transmit, based on the configuration, a preamble associated with the RACH procedure via a first RACH resource in the set of RACH resources that is associated with the first class of wireless devices, and transmit a data transmission associated with the RACH procedure via a second RACH resource in the set of RACH resources selected based on a mapping of the preamble and at least one of a multiplexing order and an OCC index associated with an OCC applied to the data transmission.

Particular aspects of the subject matter described in this disclosure can be implemented to realize one or more of the following potential advantages. In some examples, by preamble partitioning based on OCC for a RACH process, the described techniques can be used to improve the efficiency of a RACH process (e.g., reducing collisions for the RACH process).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

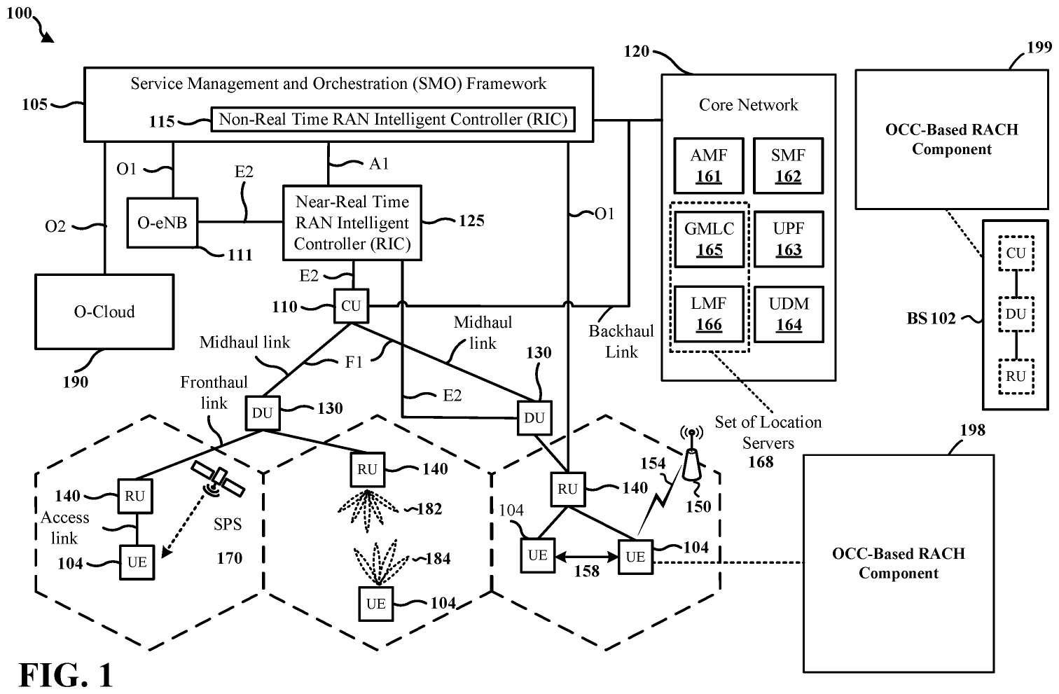

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an OCC-based RACH component 198 that may be configured to receive a configuration for a partitioning of a set of RACH resources between a first class of wireless devices supporting OCC for data transmission during a RACH procedure and a second class of wireless devices not supporting OCC for data transmission, transmit, based on the configuration, a preamble associated with the RACH procedure via a first RACH resource in the set of RACH resources that is associated with the first class of wireless devices, and transmit a data transmission associated with the RACH procedure via a second RACH resource in the set of RACH resources selected based on a mapping of the preamble and at least one of a multiplexing order and an OCC index associated with an OCC applied to the data transmission. In certain aspects, the base station 102 may have an OCC-based RACH component 199 that may be configured to transmit, to a UE, a configuration for a partitioning of a set of RACH resources between a first class of wireless devices supporting OCC for data transmission during a RACH procedure and a second class of wireless devices not supporting OCC for data transmission during the RACH procedure. The OCC-based RACH component 199 may be configured to receive, based on the configuration, a preamble associated with the RACH procedure via a first RACH resource in the set of RACH resources that is associated with the first class of wireless devices, monitor a second RACH resource in the set of RACH resources for a data transmission associated with the RACH procedure based on the preamble, a multiplexing order, and an OCC index associated with an OCC applied to the data transmission, and transmit, when the data transmission is received based on the monitoring of the second RACH resource, an additional message of the RACH procedure. Although the following description may be focused on 5G NR, the concepts described herein may be applicable to other similar areas, such as LTE, LTE-A, CDMA, GSM, and other wireless technologies.

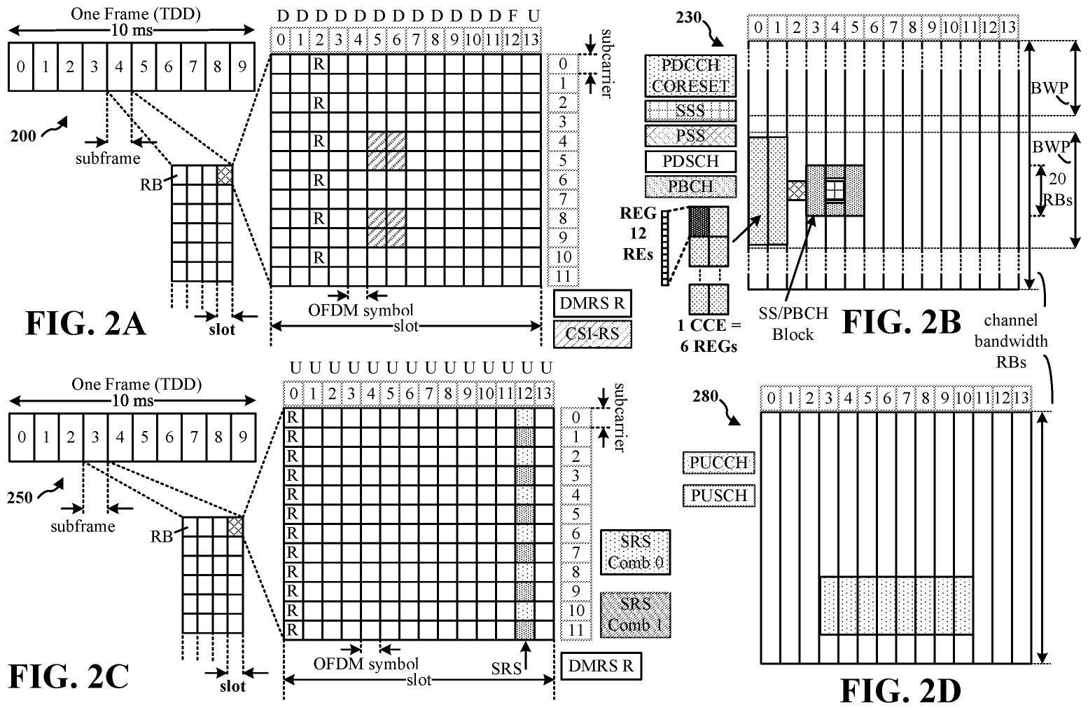

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies u 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}* 15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

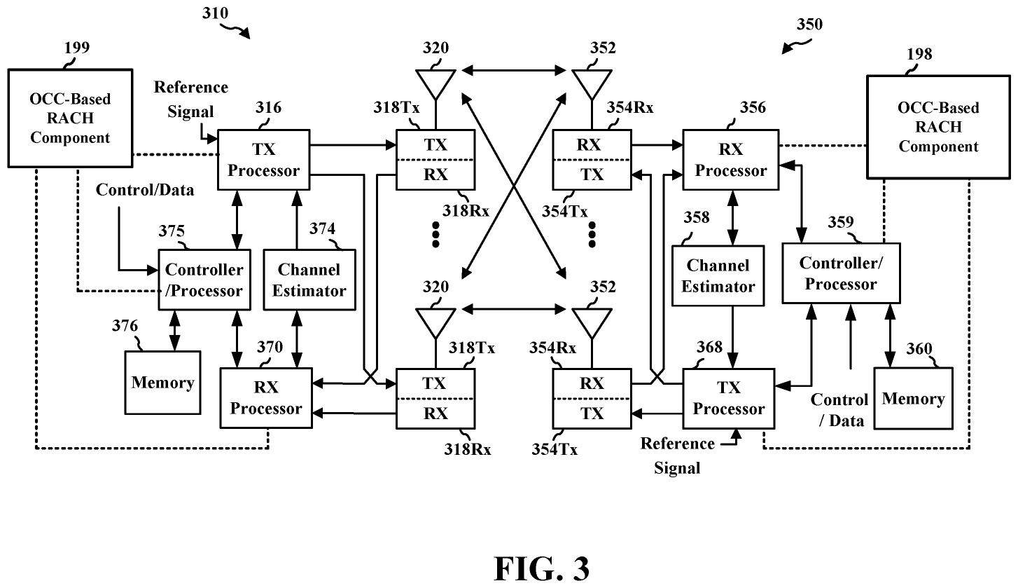

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the OCC-based RACH component 198 of FIG. 1.

At least one of the TX processor 316, the RX processor 370, and the controller/processor 375 may be configured to perform aspects in connection with the OCC-based RACH component 199 of FIG. 1.

In some aspects of wireless communication, a RACH process may be performed by a plurality of wireless devices. The RACH process may be associated with a (limited) set of RACH resources. As the RACH process, in some aspects, may be initiated by the individual UEs, a RACH process may be subject to collisions that interfere with, or lead to a failure of, the RACH process. Accordingly, methods of decreasing the likelihood of collisions in the RACH process may improve the efficiency of the RACH process.

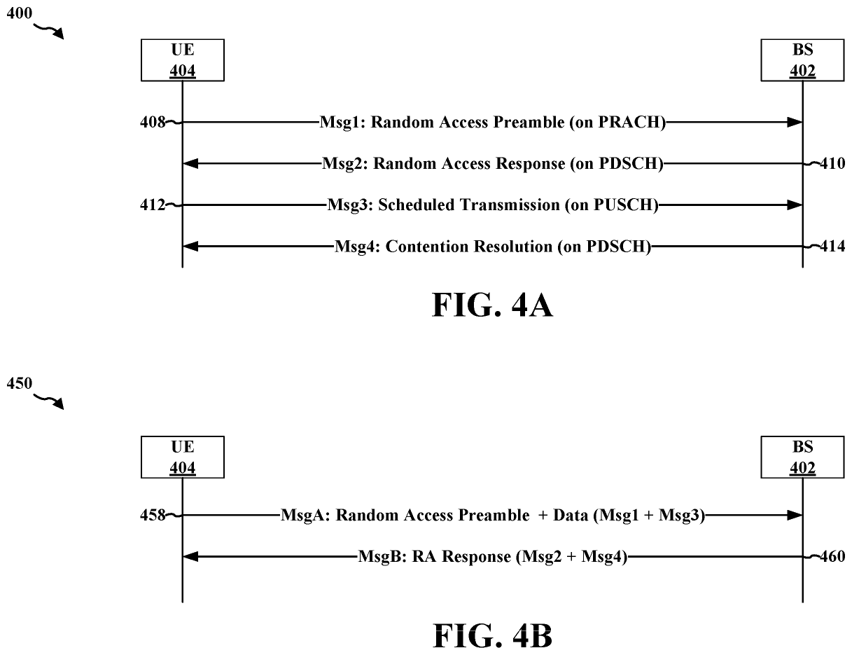

FIG. 4A is a diagram 400 illustrating elements of a 4-step RACH process in accordance with some aspects of the disclosure. A UE 404, in some aspects, may use the RACH process in an attempt to connect to a base station 402. The UE 404, in some aspects, may obtain RACH configuration information from a network in a SIB (e.g., in an idle/inactive mode of operation) or via RRC (e.g., in a connected mode). The RACH configuration information, in some aspects, may include information about RACH occasions (RO) and PUSCH occasions (PO) (and/or a PRU). In some aspects, an RO may be associated with time and frequency resources allocated for a (Msg1) preamble transmission. A PO, in some aspects, may be associated with time and frequency resources allocated for a (Msg3) PUSCH (data and/or payload) transmission. In some aspects, a PRU may be associated with a PO and a DMRS port/sequence used for a (Msg3) payload transmission.

In a 4-step RACH procedure, the UE 404 may select a preamble value from a set of valid preamble values and the UE 404 may transmit, and the base station 402 may receive, a random access preamble transmission 408 (e.g., a Msg1). The base station 402 may transmit, and the UE 404 may receive, a random access response 410 (e.g., a Msg2) including at least a resource grant for a third message of the random access process. Based on the random access response 410, the UE 404 may transmit, and the base station 402 may receive, a scheduled transmission 412 (e.g., a Msg3) via the granted resource. Based on the scheduled transmission 412, the base station 402 may transmit, and the UE 404 may receive, a fourth contention resolution message 414 (e.g., a Msg4).

FIG. 4B is a diagram 450 illustrating elements of a 2-step RACH process in accordance with some aspects of the disclosure. A UE 404, in some aspects, may use the RACH process in an attempt to connect to a base station 402. The UE 404, in some aspects, may obtain RACH configuration information from a network in a SIB (e.g., in an idle/inactive mode of operation) or via RRC (e.g., in a connected mode). The RACH configuration information, in some aspects, may include information about RACH occasions (RO) and PUSCH occasions (PO) (and/or a PUSCH resource unit (PRU)). In some aspects, an RO may be associated with time and frequency resources allocated for a (MsgA) preamble transmission. A PO, in some aspects, may be associated with time and frequency resources allocated for a (MsgA) PUSCH (data and/or payload) transmission. In some aspects, a PRU may be associated with a PO and a DMRS port/sequence used for a (MsgA) payload transmission.

In a 2-step RACH procedure, the UE 404 may select a preamble value from a set of valid preamble values and the UE 404 may transmit, and the base station 402 may receive, a first message 458 (e.g., a MsgA) including a random access preamble transmission via a first RO and a data transmission via a related PO. The related PO, in some aspects, may be identified based on a known mapping of the preamble to a PRU. Accordingly, the base station may monitor for the data transmission via the PRU based on receiving the random access preamble. Based on the first message 458, the base station 402 may transmit, and the UE 404 may receive, a second message 460 (e.g., a MsgB in a 2-step RACH). The second message 460, in some aspects, may include elements of the random access response 410 (e.g., a Msg2 in a 4-step RACH) and the fourth contention resolution message 414 (e.g., a Msg4) of FIG. 4A.

In some aspects, the 2-step RACH process may reduce latency and signaling overhead compared to the 4-step RACH. The 2-step RACH process, in some aspects, may support timing advance (TA) free and grant-free small UL packet transmission with different TB size and/or MCS. In some aspects, the 2-step RACH may improve a capacity and/or a power efficiency of 4-step contention based RACH (CBRA) and may replace a RACH-less handover.

However, the 2-step RACH process, in some aspects, may suffer performance degradation because of no TA (before the PUSCH and/or data transmission in the first message). In some aspects, there may also be a trade-off between a collision probability (of the PUSCH part of MsgA) and the resource overhead. The 4-step RACH process may map each preamble to a unique resource (e.g., UL grant) indicated in the second message or use a many to one mapping in conjunction with a contention resolution mechanism for one or more of the second message and/or the fourth message of the 4-step RACH process, while the 2-step RACH process may map multiple preambles to a same UL/PUSCH resource. Additionally, in some aspects, PUSCH resources may be wasted (e.g., may be reserved for monitoring for possible PUSCH transmissions and may unable to be assigned or allocated for other communications).

In order to address some of the drawbacks of the 2-step RACH process (or improve aspects of the 4-step RACH process), various aspects relate generally to approaches for using OCC in association with a RACH process. Some aspects more specifically relate to approaches for preamble partitioning based on OCC for one or more of a 2-step RACH process or a 4-step RACH process, and a preamble to physical uplink shared channel (PUSCH) mapping for a RACH message (e.g., a MsgA in a 2-step RACH or a Msg3 in a 4-step RACH) with OCC. In some examples, a network device may be configured to transmit, to a UE, a configuration for a partitioning of a set of RACH resources between a first class of wireless devices supporting OCC for data transmission during a RACH procedure and a second class of wireless devices not supporting OCC for data transmission during the RACH procedure. The network device may be configured to receive, based on the configuration, a preamble associated with the RACH procedure via a first RACH resource in the set of RACH resources that is associated with the first class of wireless devices, monitor a second RACH resource in the set of RACH resources for a data transmission associated with the RACH procedure based on the preamble, a multiplexing order, and an OCC index associated with an OCC applied to the data transmission, and transmit, when the data transmission is received based on the monitoring of the second RACH resource, an additional message of the RACH procedure. In an aspect of the disclosure, a method, a computer-readable medium, and an apparatus are provided. In some examples, a wireless device may be configured to receive a configuration for a partitioning of a set of RACH resources between a first class of wireless devices supporting OCC for data transmission during a RACH procedure and a second class of wireless devices not supporting OCC for data transmission, transmit, based on the configuration, a preamble associated with the RACH procedure via a first RACH resource in the set of RACH resources that is associated with the first class of wireless devices, and transmit a data transmission associated with the RACH procedure via a second RACH resource in the set of RACH resources selected based on a mapping of the preamble and at least one of a multiplexing order and an OCC index associated with an OCC applied to the data transmission.

In some aspects, using OCC in association with the RACH process may be part of a multiple access scheme used to multiplex multiple UEs, thereby increasing a capacity (e.g., the ability to have a larger number of UEs use a same set of time-and-frequency-resources). The number of UEs that may be multiplexed simultaneously, in some aspects, may be governed by a multiplexing order (M). In some aspects, multiplexing multiple UEs may create interference at the base station while OCC may be used to mitigate the interference effectively. For example, the data from each UE may be cover coded across repetitions in an orthogonal manner using an OCC. For example, for a multiplexing order of 4, four cover codes may be available, e.g., [1, 1, 1, 1], [1, −1, 1, −1], [1, 1, −1, −1], [−1, 1, −1, 1] that may be rows of an OCC matrix.

As described in relation to FIG. 4B, the MsgA PUSCH may include a DMRS and data. The multiplexing of the DMRS, in some aspects of a current (or legacy) multiplexing, may use OCC but the data may not use OCC. Accordingly, the data may be multiplexed using MU-MIMO (multiple antennas at the base station). In some aspects, the nature of uplink transmissions (e.g., that include repetitions) may facilitate the use of OCC encoding with reduced losses or other advantages (e.g., in contrast to other encoding or multiple access schemes, such as CDMA). In some aspects, OCC may be paired up with MU-MIMO to provide even more capacity gains. Hence, OCC allows another dimension for multiplexing data which adds to the uplink capacity of the network

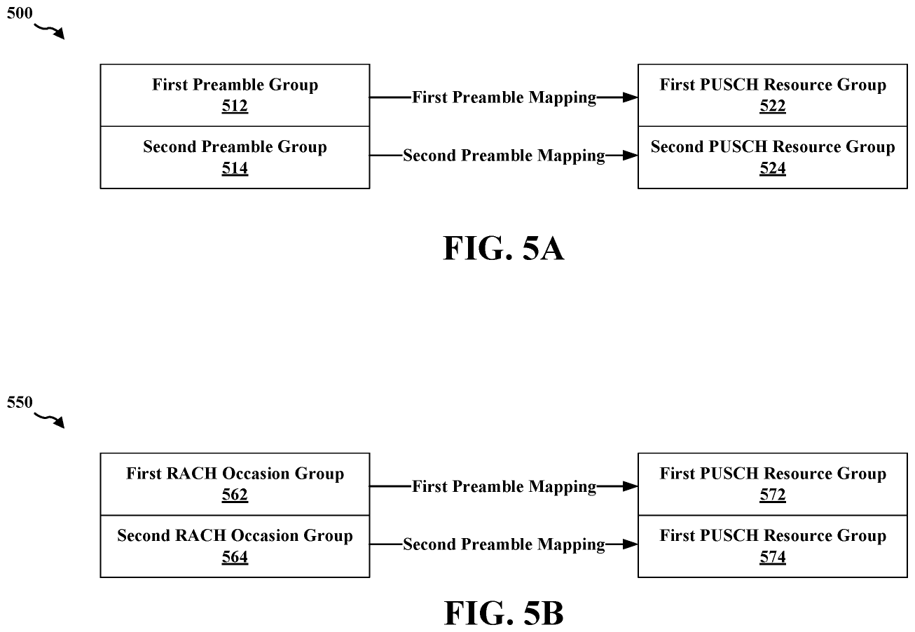

FIG. 5A is a diagram 500 illustrating a first RACH resource partitioning based on preamble resources in accordance with some aspects of the disclosure. For example, for a given RO, preamble sequences may be partitioned into two groups: a first preamble group 512 for use by a first class of wireless devices (e.g., OCC UEs) supporting OCC for data transmission during a RACH process and a second preamble group 514 for use by a second class of wireless devices (e.g., non-OCC UEs) not supporting OCC for data transmission during the RACH procedure (e.g., a current and/or legacy capability). A UE may read this partitioning from SIB1 (e.g., when operating in an idle/inactive mode) and RRC (e.g., when operating in a connected mode).

The resources allocated for POs of each group (e.g., first PUSCH resource group 522 and second PUSCH resource group 524), in some aspects, may not overlap, e.g., time and frequency resources for POs in the first PUSCH resource group 522 associated with the first preamble group 512 may be disjoint from the time and frequency resources for POs in the second PUSCH resource group 524 associated with the second preamble group 514. In some aspects, the POs may be associated with a set of repetitions (e.g., associated with redundancy version (RV) cycling or TB processing over multi-slots (TBoMS)). The first PUSCH resource group 522 may be identified based on a first mapping from the first preamble group 512 while the second PUSCH resource group 524 may be identified based on a second mapping from the second group of preambles. Accordingly, UEs of the first class of UEs that support the use of OCC for a MsgA data transmission may choose preambles from the first preamble group 512 that may be mapped using the first mapping to POs associated with the first PUSCH resource group 522 while the UEs of the second class of UEs that do not support the use of OCC for a MsgA data transmission may choose preambles from the second preamble group 514 that may be mapped using the second mapping to POs associated with the second PUSCH resource group 524.

For the first preamble group 512 and the first PUSCH resource group 522, a first preamble mapping (e.g., an OCC-based mapping) may be defined, known, or configured. In some aspects, the first preamble mapping may be an updated mapping accounting for the use of OCC. For example, the first preamble mapping may map the preambles in the first preamble group 512 to a set of resources that may be defined in terms of a first set of parameters (e.g., frequency, time, and DMRS index) as well as an OCC index where the second preamble mapping (e.g., a legacy, or non-OCC, mapping) may map the preambles in the second preamble group 514 to a set of resources that may be defined in terms of the first set of parameters without the use of the OCC index.

In some aspects, for the first preamble mapping, each consecutive number of N_{preamble} preamble indexes from valid PRACH occasions in a PRACH slot may be ordered (1) in increasing order of preamble indexes within a single PRACH occasion, then (2) in increasing order of frequency resource indexes for frequency multiplexed PRACH occasions, and finally (3) in increasing order of time resource indexes for time multiplexed PRACH occasions within a PRACH slot. The ordered preamble indexes may then be mapped to a valid PUSCH occasion and the associated DMRS resource. The mapping may be ordered (1) in increasing order of frequency resource indexes fid for frequency multiplexed PUSCH occasions, then (2) in increasing order OCC codeword index within a PUSCH occasion (where an OCC codeword index OCC_{id} is determined, e.g., calculated or looked up in a table, based on an OCC multiplexing order M and the row i of OCC matrix being used), then (3) in increasing order of DMRS resource indexes within a PUSCH occasion, where a DMRS resource index DMRS_{id} is determined first in an ascending order of a DMRS port index and second in an ascending order of a DMRS sequence index, then (4) in increasing order of time resource indexes t_{id} for time multiplexed PUSCH occasions within a PUSCH slot, and finally (5) in increasing order of indexes for Nₛ PUSCH slots, where

$${N}_{preamble} = ceil ( \frac{{T}_{preamble}}{{T}_{PUSCH}} ) ,$$

T_{preamble} is a total number of valid PRACH occasions per association pattern period multiplied by the number of preambles per valid PRACH occasion provided by a first configuration (e.g., a rach-ConfigCommonTwoStepRA), and T_{PUSCH} is a total number of valid PUSCH occasions per PUSCH configuration per association pattern period multiplied by the number of DMRS resource indexes per valid PUSCH occasion provided by an additional configuration (e.g., msgA-DMRS-Config). While a specific ordering is described above, other orderings of characteristics listed above may be configured for the first mapping. For example, the mapping may consider the DMRS resource indexes (or DMRS_{id}) before the OCC codeword index (or OCC_{id}).

For the second preamble group 514 and the second PUSCH resource group 524, a second preamble mapping (e.g., a legacy, or non-OCC, mapping) may be defined, known, or configured. For example, in some aspects, each consecutive number of N_{preamble} preamble indexes from valid PRACH occasions in a PRACH slot may be ordered (1) in increasing order of preamble indexes within a single PRACH occasion, then (2) in increasing order of frequency resource indexes for frequency multiplexed PRACH occasions, and finally (3) in increasing order of time resource indexes for time multiplexed PRACH occasions within a PRACH slot. The ordered preamble indexes may then be mapped to a valid PUSCH occasion and the associated DMRS resource. The mapping may be ordered (1) in increasing order of frequency resource indexes fid for frequency multiplexed PUSCH occasions, then (2) in increasing order of DMRS resource indexes within a PUSCH occasion, where a DMRS resource index DMRS_{id} is determined first in an ascending order of a DMRS port index and second in an ascending order of a DMRS sequence index, then (3) in increasing order of time resource indexes t_{id} for time multiplexed PUSCH occasions within a PUSCH slot, and finally (4) in increasing order of indexes for Nₛ PUSCH slots. While a specific ordering is described above, other orderings of characteristics listed above may be configured for the second mapping, where the second mapping may be configured independently from the first mapping.

FIG. 5B is a diagram 550 illustrating a first RACH resource partitioning based on RACH occasions in accordance with some aspects of the disclosure. For example, a set of ROs associated with a RACH process may be partitioned into two groups: a first RO group 562 for use by a first class of wireless devices (e.g., UEs) supporting OCC for data transmission during a RACH process and a second RO group 564 for use by a second class of wireless devices (e.g., UEs) not supporting OCC for data transmission during the RACH procedure (e.g., a current and/or legacy capability). A UE may read this partitioning from SIB1 (e.g., when operating in an idle/inactive mode) and RRC (e.g., when operating in a connected mode).

The resources allocated for POs of each group (e.g., first PUSCH resource group 572 and second PUSCH resource group 574), in some aspects, may not overlap, e.g., time and frequency resources for POs in the first PUSCH resource group 572 associated with the first RO group 562 may be disjoint from the time and frequency resources for POs in the second PUSCH resource group 574 associated with the second RO group 564. In some aspects, the POs may be associated with a set of repetitions (e.g., associated with redundancy version (RV) cycling or TBoMS). The first PUSCH resource group 572 may be identified based on a first mapping from the first RO group 562 while the second PUSCH resource group 574 may be identified based on a second mapping from the second RO group 564. Accordingly, UEs of the first class of UEs that support the use of OCC for a MsgA data transmission may choose ROs from the first RO group 562 that may be mapped using the first mapping to POs associated with the first PUSCH resource group 572 while the UEs of the second class of UEs that do not support the use of OCC for a MsgA data transmission may choose ROs from the second RO group 564 that may be mapped using the second mapping to POS associated with the second PUSCH resource group 574.

In some aspects, the first preamble mapping may be an updated mapping accounting for the use of OCC. For example, the first preamble mapping may map the preambles transmitted via ROs in the first RO group 562 to a set of resources that may be defined in terms of a first set of parameters (e.g., frequency, time, and DMRS index) as well as an OCC index where the second preamble mapping (e.g., a legacy, or non-OCC, mapping) may map the preambles transmitted via ROs in the second RO group 564 to a set of resources that may be defined in terms of the first set of parameters without the use of the OCC index.

In some aspects, for the first preamble mapping, each consecutive number of N_{preamble} preamble indexes from valid PRACH occasions in a PRACH slot (e.g., an RO in the first RO group 562) may be ordered (1) in increasing order of preamble indexes within a single PRACH occasion, then (2) in increasing order of frequency resource indexes for frequency multiplexed PRACH occasions, and finally (3) in increasing order of time resource indexes for time multiplexed PRACH occasions within a PRACH slot. The ordered preamble indexes may then be mapped to a valid PUSCH occasion and the associated DMRS resource. The mapping may be ordered (1) in increasing order of frequency resource indexes fid for frequency multiplexed PUSCH occasions, then (2) in increasing order OCC codeword index within a PUSCH occasion (where an OCC codeword index OCC_{id} is determined, e.g., calculated or looked up in a table, based on an OCC multiplexing order M and the row i of OCC matrix being used), then (3) in increasing order of DMRS resource indexes within a PUSCH occasion, where a DMRS resource index DMRS_{id} is determined first in an ascending order of a DMRS port index and second in an ascending order of a DMRS sequence index, then (4) in increasing order of time resource indexes t_{id} for time multiplexed PUSCH occasions within a PUSCH slot, and finally (5) in increasing order of indexes for Nₛ PUSCH slots. While a specific ordering is described above, other orderings of characteristics listed above may be configured for the first mapping. For example, the mapping may consider the DMRS resource indexes (or DMRS_{id}) before the OCC codeword index (or OCC_{id}).

For the second preamble group 514 and the second PUSCH resource group 524, a second preamble mapping (e.g., a legacy, or non-OCC, mapping) may be defined, known, or configured. For example, in some aspects, each consecutive number of N_{preamble} preamble indexes from valid PRACH occasions in a PRACH slot (e.g., an RO in the second RO group 564) may be ordered (1) in increasing order of preamble indexes within a single PRACH occasion, then (2) in increasing order of frequency resource indexes for frequency multiplexed PRACH occasions, and finally (3) in increasing order of time resource indexes for time multiplexed PRACH occasions within a PRACH slot. The ordered preamble indexes may then be mapped to a valid PUSCH occasion and the associated DMRS resource. The mapping may be ordered (1) in increasing order of frequency resource indexes fid for frequency multiplexed PUSCH occasions, then (2) in increasing order of DMRS resource indexes within a PUSCH occasion, where a DMRS resource index DMRS_{id} is determined first in an ascending order of a DMRS port index and second in an ascending order of a DMRS sequence index, then (3) in increasing order of time resource indexes t_{id} for time multiplexed PUSCH occasions within a PUSCH slot, and finally (4) in increasing order of indexes for Nₛ PUSCH slots. While a specific ordering is described above, other orderings of characteristics listed above may be configured for the second mapping, where the second mapping may be configured independently from the first mapping.

In order to perform the mapping, a new table defining an OCC index (e.g., OCC_{id}) (see Table 2) may be provided, where the total number of OCC indexes is N_{OCC}.

TABLE 2
OCC_{id} based on multiplexing order (M) and OCC matrix row (i)

| | Multiplexing | Row of OCC |
|---|---|---|
| OCC_{id} | Order (M) | matrix (i) |
| 1 | 2 | 1 |
| 2 | 2 | 2 |
| 3 | 3 | 1 |
| 4 | 3 | 2 |
| 5 | 3 | 3 |
| 6 | 4 | 1 |
| . . . | . . . | . . . |
| N_{OCC} | M_{Max} | M_{Max} |

Additionally, a table (or other mapping) used to identify a DMRS index (e.g., DMRS_{id}) incorporating/identifying an associated OCC index (see Table 3) may be provided. For example, each of the OCC_{id} will have to be mapped onto a DMRS_{id} (DMRS port #, CDM group #, seq #). In some aspects, DMRS and data may use separate OCC patterns. For a total number N denote the of OCC_{id}s, a separate OCC_{id} column may be added to existing mappings (e.g., in Tables 6.4.1.1.3-1 and 6.4.1.1.3-2 in TS 38.211). Accordingly, each of table will have N times the number of entries as the current table. This will result in increasing the total number of DMRS_{id}s. An example of this is seen on in Table 3 below.

TABLE 3
DMRS_{id} associated with OCC_{id}

| | | CDM | | | | | |
|---|---|---|---|---|---|---|---|
| | | group | | | wₜ (l′) | | |
| DMRS_{id} | \tilde{p} | λ | Δ | w_{f}(0) . . . w_{f}(3) | l′ = 0 | l′ = 1 | OCC_{id} |
| 0 | 0 | 0 | 0 | [+1, +1, +1, +1] | +1 | +1 | 1 |
| 1 | 1 | 0 | 0 | [+1, −1, +1, −1] | +1 | +1 | |
| 2 | 2 | 1 | 1 | [+1, +1, +1, +1] | +1 | +1 | |
| 3 | 3 | 1 | 1 | [+1, −1, +1, −1] | +1 | +1 | |
| 4 | 4 | 0 | 0 | [+1, +1, +1, +1] | +1 | −1 | |
| 5 | 5 | 0 | 0 | [+1, −1, +1, −1] | +1 | −1 | |
| 6 | 6 | 1 | 1 | [+1, +1, +1, +1] | +1 | −1 | |
| 7 | 7 | 1 | 1 | [+1, −1, +1, −1] | +1 | −1 | |
| 8 | 8 | 0 | 0 | [+1, +j, −1, −j] | +1 | +1 | |
| 9 | 9 | 0 | 0 | [+1, −j, −1, +j] | +1 | +1 | |
| 10 | 10 | 1 | 1 | [+1, +j, −1, −j] | +1 | +1 | |
| 11 | 11 | 1 | 1 | [+1, −j, −1, +j] | +1 | +1 | |
| 12 | 12 | 0 | 0 | [+1, +j, −1, −j] | +1 | −1 | |
| 13 | 13 | 0 | 0 | [+1, −j, −1, +j] | +1 | −1 | |
| 14 | 14 | 1 | 1 | [+1, +j, −1, −j] | +1 | −1 | |
| 15 | 15 | 1 | 1 | [+1, −j, −1, +j] | +1 | −1 | |
| 16 | 0 | 0 | 0 | [+1, +1, +1, +1] | +1 | +1 | 2 |
| 17 | 1 | 0 | 0 | [+1, −1, +1, −1] | +1 | +1 | |
| 18 | 2 | 1 | 1 | [+1, +1, +1, +1] | +1 | +1 | |
| 19 | 3 | 1 | 1 | [+1, −1, +1, −1] | +1 | +1 | |
| 20 | 4 | 0 | 0 | [+1, +1, +1, +1] | +1 | −1 | |
| 21 | 5 | 0 | 0 | [+1, −1, +1, −1] | +1 | −1 | |
| 22 | 6 | 1 | 1 | [+1, +1, +1, +1] | +1 | −1 | |
| 23 | 7 | 1 | 1 | [+1, −1, +1, −1] | +1 | −1 | |
| 24 | 8 | 0 | 0 | [+1, +j, −1, −j] | +1 | +1 | |
| 25 | 9 | 0 | 0 | [+1, −j, −1, +j] | +1 | +1 | |
| 26 | 10 | 1 | 1 | [+1, +j, −1, −j] | +1 | +1 | |
| 27 | 11 | 1 | 1 | [+1, −j, −1, +j] | +1 | +1 | |
| 28 | 12 | 0 | 0 | [+1, +j, −1, −j] | +1 | −1 | |
| 29 | 13 | 0 | 0 | [+1, −j, −1, +j] | +1 | −1 | |
| 30 | 14 | 1 | 1 | [+1, +j, −1, −j] | +1 | −1 | |
| 31 | 15 | 1 | 1 | [+1, −j, −1, +j] | +1 | −1 | |

In some aspects, the DMRS and data transmissions may use different OCC patterns (e.g., different multiplexing orders and or different row values).

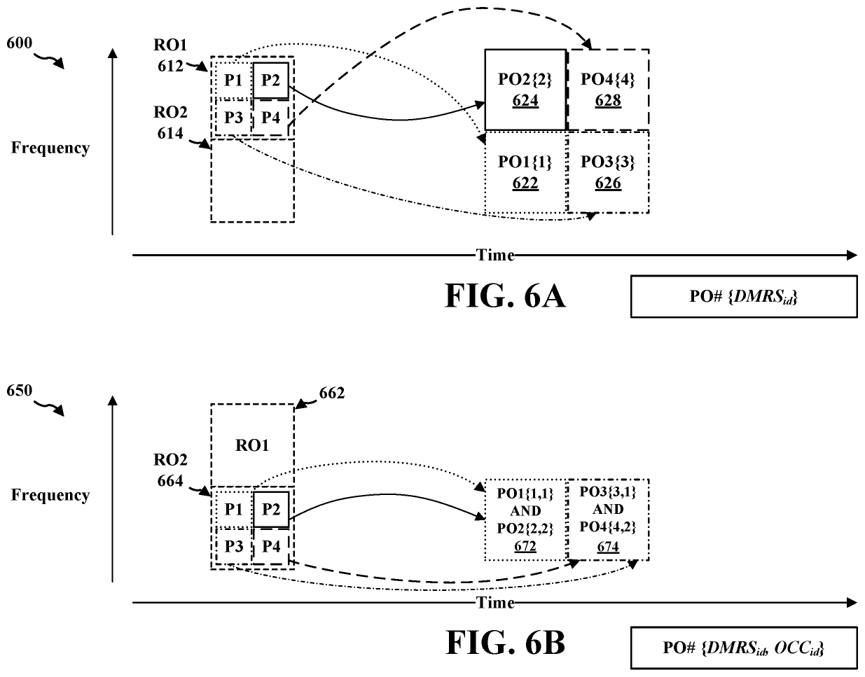

FIG. 6A is a diagram 600 illustrating a first mapping of preambles to PRUs for a data transmission associated with a RACH process in some aspects of the disclosure. For example, a first RO 612 (RO1) may be used by four UEs to transmit four different preambles (identified as P1 to P4). The ordering of the preambles, in some aspects, may be based on the second mapping describe above where, for a same RO, the frequency and time resources are the same for all the preambles P1 to P4 such that the ordering is based on an increasing order of preamble indexes within the first RO 612. Based on the ordering of preambles, the preamble mapping may indicate a PO for each UE as well as a DMRS_{id}. As shown in diagram 600, a first preamble (P1) may be mapped to a first PO 622 (e.g., PO1{1}, where for a PO designated as PO #{X}, the #is the index of the PO in an ordered list of POs and the X is the value of the DMRS_{id}) that is associated with a lowest frequency, an earliest time, and a lowest DMRS_{id}, while a second preamble (P2) is mapped to a second PO 624 (e.g., PO2 {2}) associated with a next lowest frequency at the earliest time and a next lowest DMRS_{id}. The third preamble (P3) and the fourth preamble (P4) may then be mapped to a third PO 626 (e.g., PO3 {3}) and a fourth PO 628 (e.g., PO4 {4}), respectively, at a next earliest time and using a corresponding DMRS_{id}. In some aspects, the first RO 612 may be an RO in the second RO group 564 (associated with the non-OCC UEs) as described in relation to FIG. 5B above, or the preambles may be selected from the second preamble group 514 (associated with the non-OCC UEs) as described in relation to FIG. 5A above. Similarly, the second RO 614 may be an RO associated with the first RO group 562 (associated with OCC UEs) that do not use the same (second mapping) as the first RO 612.

FIG. 6B is a diagram 650 illustrating a second mapping of preambles to PRUs for a data transmission associated with a RACH process using OCC in some aspects of the disclosure. The preamble to PUSCH mapping, in some aspects, may be based on multiplexing order (M) and OCC codeword (row of OCC matrix) being used. The codeword and multiplexing order maybe indicated by something like an OCC_{id}. For example, a second RO 664 (RO2) may be used by four UEs to transmit four different preambles (identified as P1 to P4). The ordering of the preambles, in some aspects, may be based on the mapping describe above where, for a same RO, the frequency and time resources are the same for all the preambles P1 to P4 such that the ordering is based on an increasing order of preamble indexes within the second RO 664. Based on the ordering of preambles, the preamble mapping may indicate a PO for each UE as well as a DMRS_{id} and OCC_{id}. As shown in diagram 650, a first preamble (P1) may be mapped to a first PO (e.g., PO1{1,1}) and the second preamble (P2) may be mapped to a second PO (e.g., PO2 {2,2}, where for a PO designated as PO #{X,Y}, the #is the index of the PO in an ordered list of POs, the X is the value of the DMRS_{id}, and the Y is the value of the OCC_{id}). Both the first PO and the second PO may be within a first time-and-frequency resource 672 by using an OCC of multiplexing order of at least 2. The first time-and-frequency resource 672 may be associated with a lowest frequency, an earliest time, and a lowest set of DMRS_{id}. The third preamble (P3) and the fourth preamble (P4) may then be mapped to a third PO (e.g., PO3 {3,1}) and a fourth PO (e.g., PO4 {4, 2}), respectively, within a second time-and-frequency resource 674 by using an OCC of multiplexing order of at least 2. In some aspects, the second RO 664 may be an RO associated with the first RO group 562 (associated with OCC UEs) that do not use the same (second mapping) as the first RO 662, or the preambles P1 to P4 may be selected from the first preamble group 512 (associated with the OCC UEs) as described in relation to FIG. 5A above. Similarly, the first RO 612 may be an RO in the second RO group 564 (associated with the non-OCC UEs) as described in relation to FIG. 5B above.

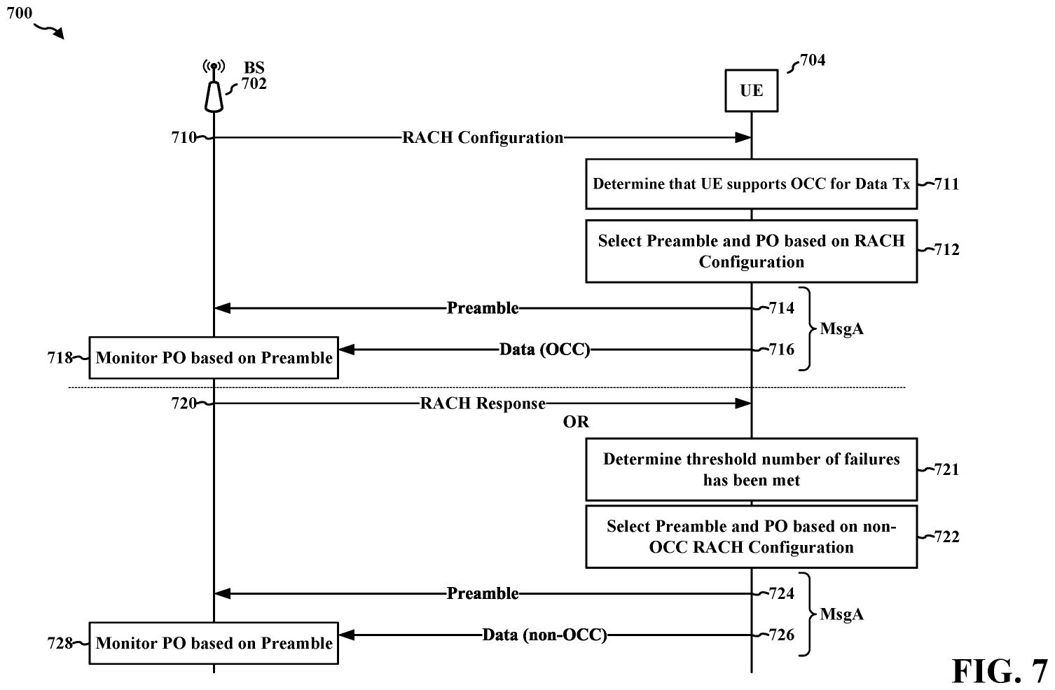

FIG. 7 is a call flow diagram 700 illustrating the use of OCC for a 2-step RACH process in accordance with some aspects of the disclosure. The method is illustrated in relation to a base station 702 (e.g., as an example of a network device or network node that may include one or more components of a disaggregated base station) in communication with a UE 704 (e.g., as an example of a wireless device). The functions ascribed to the base station 702, in some aspects, may be performed by one or more components of a network entity, a network node, or a network device (a single network entity/node/device or a disaggregated network entity/node/device as described above in relation to FIG. 1). Similarly, the functions ascribed to the UE 704, in some aspects, may be performed by one or more components of a wireless device supporting communication with a network entity/node/device. Accordingly, references to “transmitting” in the description below may be understood to refer to a first component of the base station 702 (or the UE 704) outputting (or providing) an indication of the content of the transmission to be transmitted by a different component of the base station 702 (or the UE 704). Similarly, references to “receiving” in the description below may be understood to refer to a first component of the base station 702 (or the UE 704) receiving a transmitted signal and outputting (or providing) the received signal (or information based on the received signal) to a different component of the base station 702 (or the UE 704).

The base station 702 may transmit, and a UE 704 may receive, RACH configuration 710. In some aspects, the RACH configuration 710, may include a configuration for a partitioning of a set of RACH resources between a first class of wireless devices supporting OCC for data transmission during a RACH procedure (e.g., OCC-UEs) and a second class of wireless devices not supporting OCC for data transmission during the RACH procedure (e.g., non-OCC-UEs). The set of (partitioned) RACH resources, in some aspects, may include preamble sequences and/or the set of (partitioned) RACH resources may include RACH occasions (ROs). The RACH configuration 810, in some aspects, may also indicate the multiplexing order (M). In some aspects, the RACH configuration 710 including and/or indicating the partitioning of the set of RACH resources may be one of a SIB, e.g., SIB1, or an RRC message.

At 711, the UE 704 may determine that the UE 704 is an OCC-UE that supports OCC for the RACH data transmission (e.g., a PUSCH transmission of a first step of a 2-step RACH process, or a MsgA). Based on the determination at 711, the UE 704 may select, based on the RACH configuration and/or the RACH resource partition, a preamble and/or a RACH occasion (RO) at 712. For example, the UE 704 may, based on the determination at 711 that the UE 704 is an OCC-UE and based on the RACH configuration 710 indicating the RACH resources for OCC-UEs, select a preamble from a first partition of preambles (e.g., a first set of preamble sequences) associated with the first class of wireless devices (OCC-UEs). Alternatively, or additionally, the UE 704, at 712, may select, based on the determination at 711 and the RACH configuration 710, an RO for transmitting a preamble for the RACH process (e.g., a preamble transmission of a first step of a 2-step RACH process, or a MsgA) from a first partition of ROs associated with the first class of wireless devices.

Based on the preamble and/or RO selected at 712, the UE 704 may transmit, and base station 702 may receive, a preamble transmission 714 and a data transmission 716 (e.g., a PUSCH transmission) using OCC. The UE 704, when selecting the PO and/or PRU for the data transmission 716, may use a mapping between the preamble and a corresponding PO and/or PRU as described above in relation to the first mapping between the first preamble group 512 and the first PUSCH resource group 522 or between the first RO group 562 and the first PUSCH resource group 572. For example, the mapping, in some aspects, may be based on one or more of a frequency resource index for a frequency multiplexed PO, the OCC index, the DMRS resource identifier (DMRS_{id}) value, a time resource index for time multiplexed POs, and an index for a configured number of PUSCH slots. The OCC index, in some aspects, may identify (as described in relation to Table 2 above) a multiplexing order and a row of a related OCC matrix. In some aspects, the set of POs associated with the use of OCC is a first subset of the POs for RACH that is disjoint from a second subset of the POs associated with not using OCC.

The data transmission 716 may follow the preamble transmission 714 by a configured time (e.g., a configured number of slots, ms, or symbols) that may depend on a SCS to allow the base station 702 to perform a mapping from the preamble to a PRU (e.g., a time- and frequency resource associated with a particular DMRS_{id} and OCC_{id}). Accordingly, based on the received preamble transmission 714 and the preamble-to-PO mapping, the base station may identify a corresponding PO and/or PRU to monitor and monitor, at 718, the PO and/or PRU for the data transmission 716. Based on the monitoring at 718, the base station 702 may transmit, and the UE 704 may receive, a RACH response 720 indicating a successful RACH process. The RACH response 720, in some aspects, may include contention resolution or other information for the UE to facilitate communication with the base station 702.

If, instead of success, the RACH process fails, the UE 704 may determine, at 721, that the RACH process using the OCC has failed a threshold number of times and may select, at 722, a preamble and/or RO from a set of preambles and/or ROs associated with a second partition of preambles and/or ROs indicated by the RACH configuration 710 associated with the second class of wireless devices (e.g., the non-OCC UEs). Based on the selection at 722, the UE 704 may transmit, and base station 702 may receive, the preamble 724 (e.g., via an RO associated with the second class of wireless devices). Based on the preamble, and a second preamble-to-PO mapping for non-OCC UEs, the UE 704 may transmit and the base station may (at 728) monitor for, data transmission 726 (a non-OCC data and/or PUSCH transmission).

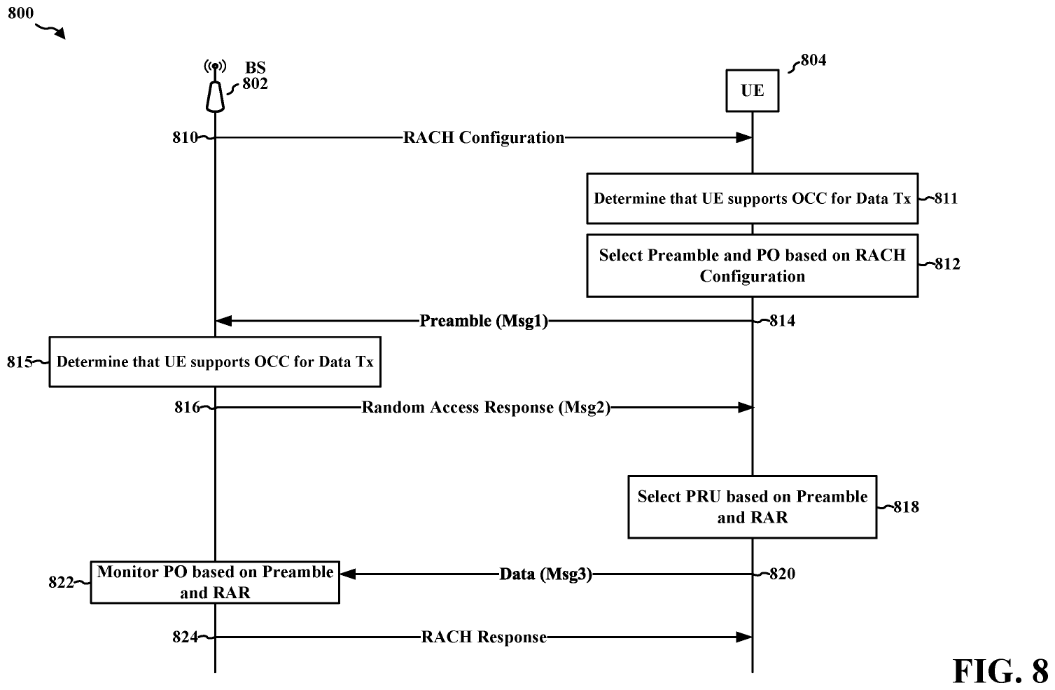

FIG. 8 is a call flow diagram 800 illustrating a method of use of OCC for a 4-step RACH process in accordance with some aspects of the disclosure. The method is illustrated in relation to a base station 802 (e.g., as an example of a network device or network node that may include one or more components of a disaggregated base station) in communication with a UE 804 (e.g., as an example of a wireless device). The functions ascribed to the base station 802, in some aspects, may be performed by one or more components of a network entity, a network node, or a network device (a single network entity/node/device or a disaggregated network entity/node/device as described above in relation to FIG. 1). Similarly, the functions ascribed to the UE 804, in some aspects, may be performed by one or more components of a wireless device supporting communication with a network entity/node/device. Accordingly, references to “transmitting” in the description below may be understood to refer to a first component of the base station 802 (or the UE 804) outputting (or providing) an indication of the content of the transmission to be transmitted by a different component of the base station 802 (or the UE 804). Similarly, references to “receiving” in the description below may be understood to refer to a first component of the base station 802 (or the UE 804) receiving a transmitted signal and outputting (or providing) the received signal (or information based on the received signal) to a different component of the base station 802 (or the UE 804).

The base station 802 may transmit, and a UE 804 may receive, RACH configuration 810. In some aspects, the RACH configuration 810, may include a configuration for a partitioning of a set of RACH resources between a first class of wireless devices supporting OCC for data transmission during a RACH procedure (e.g., OCC-UEs) and a second class of wireless devices not supporting OCC for data transmission during the RACH procedure (e.g., non-OCC-UEs). The set of (partitioned) RACH resources, in some aspects, may include preamble sequences and/or the set of (partitioned) RACH resources may include RACH occasions (ROs). The RACH configuration 810, in some aspects, may also indicate the multiplexing order (M). In some aspects, the RACH configuration 810 including and/or indicating the partitioning of the set of RACH resources may be one of a SIB, e.g., SIB1, or an RRC message.

At 811, the UE 804 may determine that the UE 804 is an OCC-UE that supports OCC for the RACH data transmission (e.g., a PUSCH transmission of a third step of a 4-step RACH process, or a Msg3). Based on the determination at 811, the UE 804 may select, based on the RACH configuration and/or the RACH resource partition, a preamble and/or a RACH occasion (RO) at 812 for a preamble transmission. For example, the UE 804 may, based on the determination at 811 that the UE 804 is an OCC-UE and based on the RACH configuration 810 indicating the RACH resources for OCC-UEs, select a preamble from a first partition of preambles (e.g., a first set of preamble sequences) associated with the first class of wireless devices (OCC-UEs). Alternatively, or additionally, the UE 804, at 812, may select, based on the determination at 811 and the RACH configuration 810, an RO for transmitting a preamble for the RACH process (e.g., a preamble transmission of a first step of a 4-step RACH process, or a Msg1) from a first partition of ROs associated with the first class of wireless devices.

Based on the preamble and/or RO selected at 812, the UE 804 may transmit, and base station 802 may receive, a preamble transmission 814. Based on the preamble and/or the RO selected at 812, the base station may, at 815, determine and/or identify that the UE 804 supports the use of OCC for a data and/or PUSCH transmission. In some aspects, the preamble may be mapped to a first default OCC_{id} (e.g., indicating a multiplexing order and OCC row index) associated with a subsequent data transmission. Based on the determination at 815, the base station 802 may transmit a random access response (RAR) 816 (e.g., a Msg2) including parameters to use for a subsequent PUSCH and/or data transmission (e.g., a Msg3). In some aspects, the RAR 816 may be an enhanced format RAR message including a first set of parameters (e.g., a resource grant, a TA, etc.) for a data and/or PUSCH transmission as well as OCC information (e.g., an OCC index or multiplexing order and OCC row index used to derive the OCC index, the DMRS index or a PRU) when the base station 802 has determined not to use the first default OCC_{id} (multiplexing order and OCC row index) indicated in the preamble transmission 814. If, however, the base station 802 has determined to use the OCC_{id} (multiplexing order and OCC row index) indicated in the preamble transmission 814, the RAR 816 may use an unenhanced format (e.g., a standard and/or current format). In other aspects, the preamble transmission may indicate, via a (first) mapping as described in relation to FIG. 5A, 5B, or 6B, an OCC index and/or a DMRS index such that the RAR 816 may not be enhanced, but the RACH resources may still be expanded by using OCC for ROs in a partition for UEs supporting OCC for data transmission in a RACH process. Accordingly, the base station after transmitting the RAR 816 has the information used to determine a PO and/or PRU to monitor at 822 for the data and/or PUSCH transmission.

At 818, the UE 804 may select, determine, and or identify a PRU (e.g., a time-and-frequency resource associated with a DMRS_{id}, where the DMRS_{id} may indicate, for example, the OCC_{id} and the other parameters included in Table 3 above) for a PUSCH and/or data transmission 820 based on the preamble and/or the RAR 816. For example, if the RAR 816 does not include an indication of an overriding OCC_{id}, the PRU may be selected based on the OCC_{id} indicated by the mapping from the preamble, while if the RAR 816 includes an indication of an overriding OCC_{id}, the PRU may be selected based on the OCC_{id} indicated in the RAR 816. Based on the selection, determination, and/or identification at 818, the UE 804 may transmit, and the base station 802 may receive, data transmission 820 (e.g., a Msg3). Based on receiving the data transmission 820, the base station 802 may transmit, and the UE 804 may receive, a RACH response 824 indicating a successful RACH process. The RACH response 824, in some aspects, may include contention resolution or other information for the UE to facilitate communication with the base station 802.

Although not illustrated in call flow diagram 800, if, instead of success, the RACH process fails, the UE 804 may determine that the RACH process using the OCC has failed a threshold number of times and may select a preamble and/or RO from a set of preambles and/or ROs associated with a second partition of preambles and/or ROs indicated by the RACH configuration 810 associated with the second class of wireless devices (e.g., the non-OCC UEs). Based on the selection, the UE 804 may transmit, and base station 802 may receive, a preamble (e.g., via an RO associated with the second class of wireless devices). Based on the preamble, and a second preamble-to-PO mapping for non-OCC UEs, the base station 802 may allocate and/or assign resources for a data transmission based on identifying the UE as a non-OCC UE.

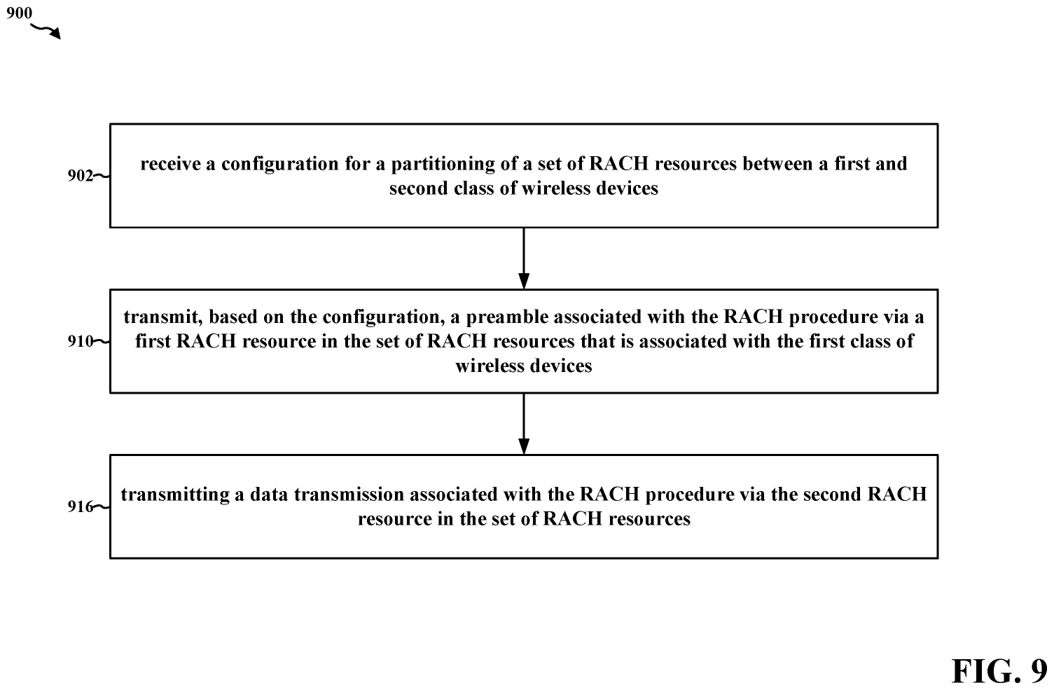

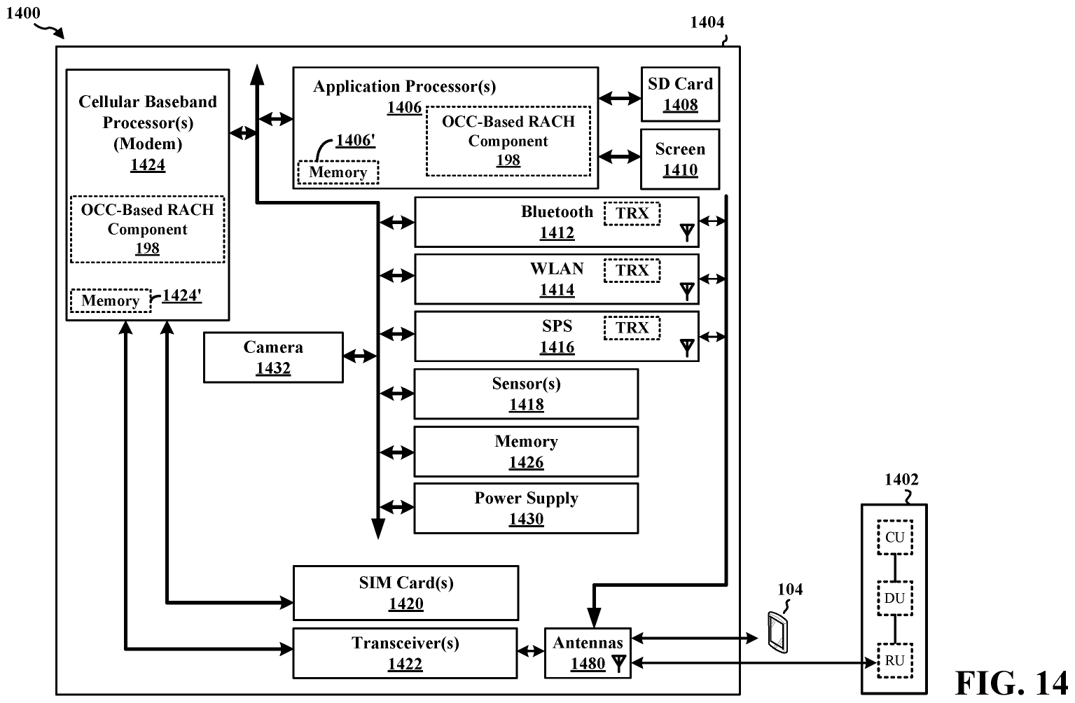

FIG. 9 is a flowchart 900 of a method of wireless communication. The method may be performed by a wireless device such as a UE (e.g., the UE 104, 704, 804; the apparatus 1404). At 902, the UE may receive a configuration for a partitioning of a set of RACH resources between a first class of wireless devices supporting OCC for data transmission during a RACH procedure and a second class of wireless devices not supporting OCC for data transmission. For example, 902 may be performed by application processor(s) 1406, cellular baseband processor(s) 1424, transceiver(s) 1422, antenna(s) 1480, and/or OCC-based RACH component 198 of FIG. 14. In some aspects, the set of RACH resources may include preamble sequences such that a first subset of preambles (e.g., candidate preambles) is associated with the first class of wireless devices and a second (disjoint) subset of preambles is associated with the second class of wireless devices. The set of RACH resources, in some aspects, may include ROs such that a first subset of ROs is associated with the first class of wireless devices and a second (disjoint) subset of ROs is associated with the second class of wireless devices. In some aspects, the configuration for the partitioning of the set of RACH resources may be indicated in one of a SIB (e.g., SIB1) or an RRC message. The configuration, in some aspects, may include (or define) at least a preamble mapping (e.g., a mapping from preamble values to POs or PRUs associated with the use of OCC for data transmissions in a RACH process) based on the preamble is mapped to the second RACH resource for the data transmission based on one or more of a frequency resource index for a frequency multiplexed PO, an OCC index, a DMRS resource identifier value, a time resource index for time multiplexed POs, and an index for a configured number of PUSCH slots. For example, referring to FIGS. 5A, 5B, 6A, 6B, 7, and 8, the UE 704 (or 804) may receive RACH configuration 710 (or 810) indicating a partitioning such as the partitioning illustrated in FIGS. 5A and 5B and/or a preamble mapping as indicated in FIGS. 5A, 5B, 6A, and/or 6B.

In some aspects, the UE may determine that the wireless device belongs to the first class of wireless devices. Referring, for example, to FIGS. 7 and 8, the UE 704 (or 804) may determine at 711 (or 811) that the UE 704 is an OCC-UE that supports OCC for the RACH data transmission (e.g., for a PUSCH transmission of a first step of a 2-step RACH process or for a PUSCH transmission of a third step of a 4-step RACH process).

In some aspects, the UE may select a preamble associated with the RACH procedure based on the determination that the wireless device belongs to the first class of wireless devices. In some aspects, the preamble associated with the RACH procedure is selected from the first set of preamble sequences associated with the first class of wireless devices as indicted in the configuration received at 902. In some aspects, selecting the preamble associated with the RACH procedure may include selecting a RO for transmitting a preamble, where the selected RACH resource may be a first RO associated with the first class of wireless device as indicated in the configuration received at 902. For example, referring to FIGS. 5A, 5B, 7, and 8, the UE 704 (or 804) may select at 712 (or 812) resources (e.g., a preamble and/or RO) for a preamble transmission 714 (or 814) based on a partitioning (such as the partitioning described in FIGS. 5A and 5B) received in RACH configuration 710 (or 810).

In some aspects associated with a 2-step RACH procedure, the UE may select (or determine and/or identify), for a data transmission associated with the RACH procedure, a second RACH resource in the set of RACH resources based on a mapping of the preamble and at least one of a multiplexing order and an OCC index associated with an OCC applied to the data transmission. In some aspects, the second RACH resource may be associated with a DMRS resource identifier value (e.g., a DMRS_{id}) and the DMRS resource identifier value may be mapped to at least one of a DMRS port number, a code division multiplexing group number, a sequence number, or the OCC index (e.g., the OCC_{id}). In some aspects, the preamble may be mapped to the second RACH resource for the data transmission based on one or more of a frequency resource index for a frequency multiplexed PO, the OCC index (OCC_{id}), the DMRS resource identifier (DMRS_{id}) value, a time resource index for time multiplexed POs, and an index for a configured number of PUSCH slots. For example, referring to FIGS. 5A, 5B, 7, and 8, the UE 704 (or 804) may select at 712 (or 812) resources (e.g., a PO) for a data transmission 716 (or 820) based on a partitioning and mapping (such as the partitioning described in FIGS. 5A and 5B and/or the mapping described in FIGS. 5A, 5B, and 6B) received in RACH configuration 710 (or 810).

At 910, the UE may transmit, based on the configuration, a preamble associated with the RACH procedure via a first RACH resource in the set of RACH resources that is associated with the first class of wireless devices. For example, 910 may be performed by application processor(s) 1406, cellular baseband processor(s) 1424, transceiver(s) 1422, antenna(s) 1480, and/or OCC-based RACH component 198 of FIG. 14. In some aspects, the set of RACH resources includes preamble sequences and the preamble associated with the RACH procedure is selected from a first set of preamble sequences associated with the first class of wireless devices, or the set of RACH resources includes ROs and the first RACH resource is a first RO associated with the first class of wireless devices. In some aspects associated with a 4-step RACH procedure, the preamble may be associated with and/or indicate an OCC index (e.g., a first OCC_{id} associated with a multiplexing order and OCC row index) to be applied to the data (PUSCH) transmission associated with the third message (e.g., a Msg3) of the 4-step RACH procedure. For example, referring to FIGS. 7 and 8, the UE 704 or 804 may transmit preamble transmission 714 or 814 via a resource, and including a preamble, selected at 712 or 812.

In some aspects associated with a 4-step RACH procedure, the UE may receive, in a second message of the 4-step RACH procedure (e.g., a RAR), an indication of the multiplexing order and the OCC row index (e.g., an OCC index or OCC_{id}) associated with the OCC applied to the data transmission associated with the third message when the base station has determined not to use the OCC index indicated in the preamble transmitted at 910. In some aspects, the second message may be an updated RAR format including the additional information regarding the OCC index. If, however, the base station has determined to use the OCC index (e.g., the first OCC_{id}) indicated in the preamble transmitted at 910, the second message of the 4-step RACH procedure may use an unenhanced format (e.g., a standard and/or current format). For example, referring to FIG. 8 the UE 804 may receive RAR 816 including an indication of the OCC index or a PO and/or a PRU.

In some aspects associated with a 4-step RACH procedure, the UE may select (or determine and/or identify), for a data transmission associated with the RACH procedure, a second RACH resource in the set of RACH resources based on a mapping of the preamble and at least one of a multiplexing order and an OCC index associated with an OCC applied to the data transmission (e.g., indicated in either of the preamble or the RAR). The RACH resource, in some aspects, may be indicated by the second message and/or by a mapping from the preamble. In some aspects, the second RACH resource may be associated with a DMRS resource identifier value (e.g., a DMRS_{id}) and the DMRS resource identifier value may be mapped to at least one of a DMRS port number, a code division multiplexing group number, a sequence number, or the OCC index (e.g., the OCC_{id}). In some aspects, the preamble may be mapped to the second RACH resource for the data transmission based on one or more of a frequency resource index for a frequency multiplexed PO, the OCC index (OCC_{id}), the DMRS resource identifier (DMRS_{id}) value, a time resource index for time multiplexed POs, and an index for a configured number of PUSCH slots. For example, referring to FIGS. 5A, 5B, and 8, the UE 804 may select at 818 resources (e.g., a PRU) for a data transmission 820 based on a partitioning and mapping (such as the partitioning described in FIGS. 5A and 5B and/or the mapping described in FIGS. 5A, 5B, and 6B) received in RACH configuration 810.

At 916, the UE may transmit a data transmission associated with the RACH procedure via a second RACH resource in the set of RACH resources selected based on a mapping of the preamble and at least one of a multiplexing order and an OCC index associated with an OCC applied to the data transmission. For example, 916 may be performed by application processor(s) 1406, cellular baseband processor(s) 1424, transceiver(s) 1422, antenna(s) 1480, and/or OCC-based RACH component 198 of FIG. 14. In some aspects, the second RACH resource in the set of RACH resources is in a subset of RACH POs associated with the first class of wireless devices. The RACH procedure, in some aspects, may be a two-step RACH procedure and the preamble transmitted at 910 and the data transmission transmitted at 912 are associated with a first message of a first step of the two-step RACH procedure. The second RACH resource, in some aspects, may be associated with a DMRS resource identifier value (e.g., a DMRS_{id}), wherein the DMRS resource identifier value is mapped to at least one of a DMRS port number, a code division multiplexing group number, a sequence number, or the OCC index. In some aspects the first message (e.g., via the preamble transmitted at 910) indicates the multiplexing order and a row of an OCC matrix associated with the data transmission. In some aspects, the OCC index may be mapped to a combination of the multiplexing order and the row of the OCC matrix (e.g., as described above in Table 2). For example, referring to FIGS. 5A, 5B, 6B, 7, and 8, the UE 704 or 804 may transmit data transmission 716 or 820 via a PO and/or PRU selected, determined, and/or identified at 712 or 818 based on a mapping as illustrated in FIGS. 5A, 5B, and 6B.

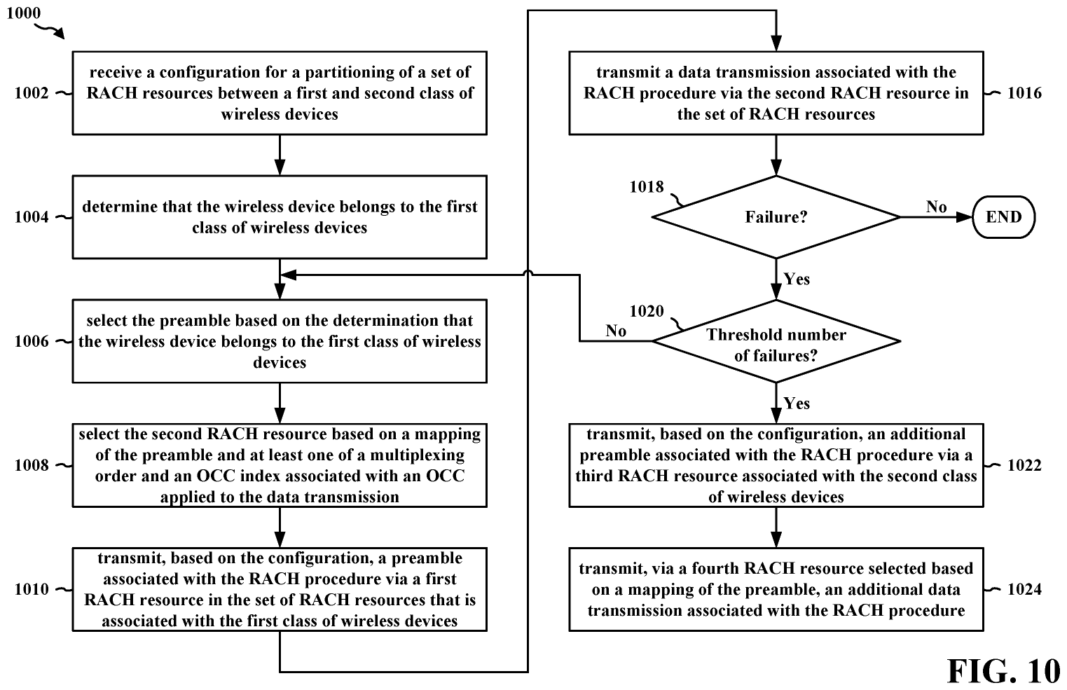

FIG. 10 is a flowchart 1000 of a method of wireless communication. The method may be performed by a wireless device such as a UE (e.g., the UE 104, 704; the apparatus 1404). At 1002, the UE may receive a configuration for a partitioning of a set of RACH resources between a first class of wireless devices supporting OCC for data transmission during a RACH procedure and a second class of wireless devices not supporting OCC for data transmission. For example, 1002 may be performed by application processor(s) 1406, cellular baseband processor(s) 1424, transceiver(s) 1422, antenna(s) 1480, and/or OCC-based RACH component 198 of FIG. 14. In some aspects, the set of RACH resources may include preamble sequences such that a first subset of preambles (e.g., candidate preambles) is associated with the first class of wireless devices and a second (disjoint) subset of preambles is associated with the second class of wireless devices. The set of RACH resources, in some aspects, may include ROs such that a first subset of ROs is associated with the first class of wireless devices and a second (disjoint) subset of ROs is associated with the second class of wireless devices. In some aspects, the configuration for the partitioning of the set of RACH resources may be indicated in one of a SIB (e.g., SIB1) or an RRC message. The configuration, in some aspects, may include (or define) at least a preamble mapping (e.g., a mapping from preamble values to POs or PRUs associated with the use of OCC for data transmissions in a RACH process) based on the preamble is mapped to the second RACH resource for the data transmission based on one or more of a frequency resource index for a frequency multiplexed PO, an OCC index, a DMRS resource identifier value, a time resource index for time multiplexed POs, and an index for a configured number of PUSCH slots. For example, referring to FIGS. 5A, 5B, 6A, 6B, and 7, the UE 704 may receive RACH configuration 710 indicating a partitioning such as the partitioning illustrated in FIGS. 5A and 5B and/or a preamble mapping as indicated in FIGS. 5A, 5B, 6A, and/or 6B.

At 1004, the UE may determine that the wireless device belongs to the first class of wireless devices. For example, 1004 may be performed by application processor(s) 1406, cellular baseband processor(s) 1424, transceiver(s) 1422, antenna(s) 1480, and/or OCC-based RACH component 198 of FIG. 14. Referring, for example, to FIG. 7, the UE 704 may determine at 711 that the UE 704 is an OCC-UE that supports OCC for the RACH data transmission (e.g., for a PUSCH transmission of a first step of a 2-step RACH process).

At 1006, the UE may select a preamble associated with the RACH procedure based on the determination that the wireless device belongs to the first class of wireless devices. For example, 1006 may be performed by application processor(s) 1406, cellular baseband processor(s) 1424, transceiver(s) 1422, antenna(s) 1480, and/or OCC-based RACH component 198 of FIG. 14. In some aspects, the preamble associated with the RACH procedure is selected from the first set of preamble sequences associated with the first class of wireless devices as indicted in the configuration received at 1002. In some aspects, selecting the preamble associated with the RACH procedure may include selecting a RO for transmitting a preamble, where the selected RACH resource may be a first RO associated with the first class of wireless device as indicated in the configuration received at 1002. For example, referring to FIGS. 5A, 5B, and 7, the UE 704 may select at 712 resources (e.g., a preamble and/or RO) for a preamble transmission 714 based on a partitioning (such as the partitioning described in FIGS. 5A and 5B) received in RACH configuration 710.

At 1008, the UE may select (or determine and/or identify), for a data transmission associated with the RACH procedure, a second RACH resource in the set of RACH resources based on a mapping of the preamble and at least one of a multiplexing order and an OCC index associated with an OCC applied to the data transmission. For example, 1008 may be performed by application processor(s) 1406, cellular baseband processor(s) 1424, transceiver(s) 1422, antenna(s) 1480, and/or OCC-based RACH component 198 of FIG. 14. In some aspects, the second RACH resource may be associated with a DMRS resource identifier value (e.g., a DMRS_{id}) and the DMRS resource identifier value may be mapped to at least one of a DMRS port number, a code division multiplexing group number, a sequence number, or the OCC index (e.g., the OCC_{id}). In some aspects, the preamble may be mapped to the second RACH resource for the data transmission based on one or more of a frequency resource index for a frequency multiplexed PO, the OCC index (OCC_{id}), the DMRS resource identifier (DMRS_{id}) value, a time resource index for time multiplexed POs, and an index for a configured number of PUSCH slots. For example, referring to FIGS. 5A, 5B, and 7, the UE 704 may select at 712 resources (e.g., a PO) for a data transmission 716 based on a partitioning and mapping (such as the partitioning described in FIGS. 5A and 5B and/or the mapping described in FIGS. 5A, 5B, and 6B) received in RACH configuration 710.

At 1010, the UE may transmit, based on the configuration, a preamble associated with the RACH procedure via a first RACH resource in the set of RACH resources that is associated with the first class of wireless devices. For example, 1010 may be performed by application processor(s) 1406, cellular baseband processor(s) 1424, transceiver(s) 1422, antenna(s) 1480, and/or OCC-based RACH component 198 of FIG. 14. In some aspects, the set of RACH resources includes preamble sequences and the preamble associated with the RACH procedure is selected from a first set of preamble sequences associated with the first class of wireless devices, or the set of RACH resources includes ROs and the first RACH resource is a first RO associated with the first class of wireless devices. For example, referring to FIG. 7, the UE 704 may transmit, and base station 702 may receive, preamble transmission 714 via a resource, and including a preamble, selected at 712.

At 1016, the UE may transmit a data transmission associated with the RACH procedure via a second RACH resource in the set of RACH resources selected based on a mapping of the preamble and at least one of a multiplexing order and an OCC index associated with an OCC applied to the data transmission. For example, 1016 may be performed by application processor(s) 1406, cellular baseband processor(s) 1424, transceiver(s) 1422, antenna(s) 1480, and/or OCC-based RACH component 198 of FIG. 14. In some aspects, the second RACH resource in the set of RACH resources is in a subset of RACH POs associated with the first class of wireless devices. The RACH procedure, in some aspects, may be a two-step RACH procedure and the preamble transmitted at 1010 and the data transmission transmitted at 1016 are associated with a first message of a first step of the two-step RACH procedure. The second RACH resource, in some aspects, may be associated with a DMRS resource identifier value (e.g., a DMRS_{id}), wherein the DMRS resource identifier value is mapped to at least one of a DMRS port number, a code division multiplexing group number, a sequence number, or the OCC index. In some aspects the first message (e.g., via the preamble transmitted at 1010) indicates the multiplexing order and a row of an OCC matrix associated with the data transmission. In some aspects, the OCC index may be mapped to a combination of the multiplexing order and the row of the OCC matrix (e.g., as described above in Table 2). For example, referring to FIGS. 5A, 5B, 6B, and 7, the UE 704 may transmit, and base station 702 may receive, data transmission 716 via a PO and/or PRU selected, determined, and/or identified at 712 based on a mapping as illustrated in FIGS. 5A, 5B, and 6B.

At 1018, the UE may determine if the RACH procedure has failed. For example, 1018 may be performed by application processor(s) 1406, cellular baseband processor(s) 1424, transceiver(s) 1422, antenna(s) 1480, and/or OCC-based RACH component 198 of FIG. 14. In some aspects, the determination at 1018, may be based on receiving, or failing to receive, an additional message of the RACH procedure. If an additional message of the RACH procedure is received (a failure is not detected or a success is detected), the RACH procedure may end. For example, referring to FIG. 7, the UE 704 may receive RACH response 720 and determine that the RACH procedure was successful and/or did not fail.

But if the UE determines that the RACH procedure has failed, the UE may proceed, at 1020, to determine if a threshold number of RACH failures has occurred. For example, 1018 may be performed by application processor(s) 1406, cellular baseband processor(s) 1424, transceiver(s) 1422, antenna(s) 1480, and/or OCC-based RACH component 198 of FIG. 14. If the threshold number of failures has not been met, the UE may return to 1006 to select a preamble and RACH resources for another RACH process using resources associated with the use of OCC for the data transmission. However, if the UE determines that the threshold number of failures has occurred, the UE may, at 1022 transmit, based on the configuration, an additional preamble associated with the RACH procedure via a third RACH resource associated with the second class of wireless devices and, at 1024, may transmit, via a fourth RACH resource selected based on a mapping of the preamble, an additional data transmission associated with the RACH procedure. For example, 1022 and 1024 may be performed by application processor(s) 1406, cellular baseband processor(s) 1424, transceiver(s) 1422, antenna(s) 1480, and/or OCC-based RACH component 198 of FIG. 14. For example, referring to FIG. 7, the UE 704 may determine, at 721, that the RACH process using the OCC has failed a threshold number of times and may select, at 722, a preamble and/or RO from a set of preambles and/or ROs associated with a second partition of preambles and/or ROs indicated by the RACH configuration 710 associated with the second class of wireless devices (e.g., the non-OCC UEs) and transmit the preamble 724 and the data transmission 726.

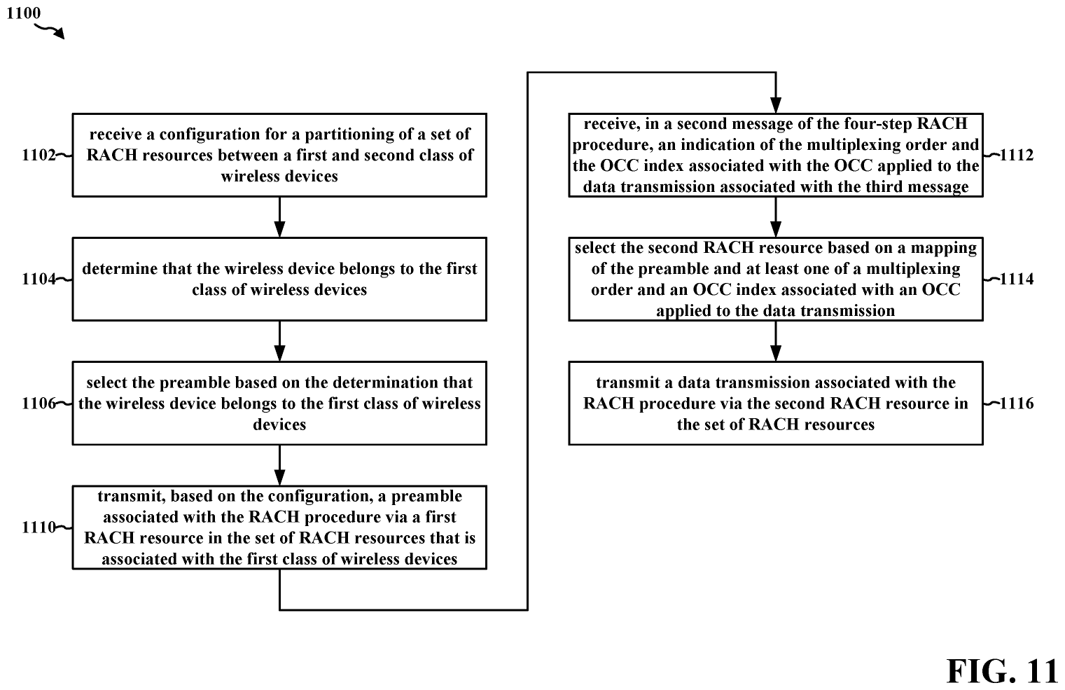

FIG. 11 is a flowchart 1100 of a method of wireless communication. The method may be performed by a wireless device such as a UE (e.g., the UE 104, 804; the apparatus 1404). At 1102, the UE may receive a configuration for a partitioning of a set of RACH resources between a first class of wireless devices supporting OCC for data transmission during a RACH procedure and a second class of wireless devices not supporting OCC for data transmission. For example, 1102 may be performed by application processor(s) 1406, cellular baseband processor(s) 1424, transceiver(s) 1422, antenna(s) 1480, and/or OCC-based RACH component 198 of FIG. 14. In some aspects, the set of RACH resources may include preamble sequences such that a first subset of preambles (e.g., candidate preambles) is associated with the first class of wireless devices and a second (disjoint) subset of preambles is associated with the second class of wireless devices. The set of RACH resources, in some aspects, may include ROs such that a first subset of ROs is associated with the first class of wireless devices and a second (disjoint) subset of ROs is associated with the second class of wireless devices. In some aspects, the configuration for the partitioning of the set of RACH resources may be indicated in one of a SIB (e.g., SIB1) or an RRC message. The configuration, in some aspects, may include (or define) at least a preamble mapping (e.g., a mapping from preamble values to POs or PRUs associated with the use of OCC for data transmissions in a RACH process) based on the preamble is mapped to the second RACH resource for the data transmission based on one or more of a frequency resource index for a frequency multiplexed PO, an OCC index, a DMRS resource identifier value, a time resource index for time multiplexed POs, and an index for a configured number of PUSCH slots. For example, referring to FIGS. 5A, 5B, 6A, 6B, and 8, the UE 804 may receive RACH configuration 810 indicating a partitioning such as the partitioning illustrated in FIGS. 5A and 5B and/or a preamble mapping as indicated in FIGS. 5A, 5B, 6A, and/or 6B.

At 1104, the UE may determine that the wireless device belongs to the first class of wireless devices. For example, 1104 may be performed by application processor(s) 1406, cellular baseband processor(s) 1424, transceiver(s) 1422, antenna(s) 1480, and/or OCC-based RACH component 198 of FIG. 14. Referring, for example, to FIG. 8, the UE 804 may determine at 811 that the UE 804 is an OCC-UE that supports OCC for the RACH data transmission (e.g., for a PUSCH transmission of a third step of a 4-step RACH process).

At 1106, the UE may select a preamble associated with the RACH procedure based on the determination that the wireless device belongs to the first class of wireless devices. For example, 1106 may be performed by application processor(s) 1406, cellular baseband processor(s) 1424, transceiver(s) 1422, antenna(s) 1480, and/or OCC-based RACH component 198 of FIG. 14. In some aspects, the preamble associated with the RACH procedure is selected from the first set of preamble sequences associated with the first class of wireless devices as indicted in the configuration received at 1102. In some aspects, selecting the preamble associated with the RACH procedure may include selecting a RO for transmitting a preamble, where the selected RACH resource may be a first RO associated with the first class of wireless device as indicated in the configuration received at 1102. For example, referring to FIGS. 5A, 5B, and 8, the UE 804 may select at 812 resources (e.g., a preamble and/or RO) for a preamble transmission 814 based on a partitioning (such as the partitioning described in FIGS. 5A and 5B) received in RACH configuration 810.

At 1110, the UE may transmit, based on the configuration, a preamble associated with the RACH procedure via a first RACH resource in the set of RACH resources that is associated with the first class of wireless devices. For example, 1110 may be performed by application processor(s) 1406, cellular baseband processor(s) 1424, transceiver(s) 1422, antenna(s) 1480, and/or OCC-based RACH component 198 of FIG. 14. In some aspects, the set of RACH resources includes preamble sequences and the preamble associated with the RACH procedure is selected from a first set of preamble sequences associated with the first class of wireless devices, or the set of RACH resources includes ROs and the first RACH resource is a first RO associated with the first class of wireless devices. In some aspects associated with a 4-step RACH procedure, the preamble may be associated with and/or indicate an OCC index (e.g., a first OCC_{id} associated with a multiplexing order and OCC row index) to be applied to the data (PUSCH) transmission associated with the third message (e.g., a Msg3) of the 4-step RACH procedure. For example, referring to FIG. 8 the UE 804 may transmit preamble transmission 814 via a resource, and including a preamble, selected at 812.

At 1112, the UE may receive, in a second message of the 4-step RACH procedure, an indication of the multiplexing order and the OCC row index (e.g., an OCC index or OCC_{id}) associated with the OCC applied to the data transmission associated with the third message. In some aspects, the second message may be (or use) an updated RAR format including the additional information regarding the OCC index (e.g., an overriding OCC index) used when the base station has determined not to use the OCC index indicated in the preamble transmitted at 1110. For example, 1112 may be performed by application processor(s) 1406, cellular baseband processor(s) 1424, transceiver(s) 1422, antenna(s) 1480, and/or OCC-based RACH component 198 of FIG. 14. If, however, the base station has determined to use the OCC index (e.g., the first OCC_{id}) indicated in the preamble transmitted at 1110, the second message of the 4-step RACH procedure may indicate the multiplexing order and the OCC row index associated with the OCC index to be applied to the data transmission associated with the third message by using an unenhanced format (e.g., a standard and/or current format) that does not include an overriding OCC index. For example, referring to FIG. 8 the UE 804 may receive RAR 816 including an indication of the OCC index or a PO and/or a PRU.

At 1114, the UE may select (or determine and/or identify), for a data transmission associated with the RACH procedure, a second RACH resource in the set of RACH resources based on a mapping of the preamble and at least one of a multiplexing order and an OCC index associated with an OCC applied to the data transmission (e.g., indicated in either of the preamble or the RAR). For example, 1114 may be performed by application processor(s) 1406, cellular baseband processor(s) 1424, transceiver(s) 1422, antenna(s) 1480, and/or OCC-based RACH component 198 of FIG. 14. The RACH resource, in some aspects, may be indicated by the second message received at 1112 and/or by a mapping from the preamble transmitted at 1110. In some aspects, the second RACH resource may be associated with a DMRS resource identifier value (e.g., a DMRS_{id}) and the DMRS resource identifier value may be mapped to at least one of a DMRS port number, a code division multiplexing group number, a sequence number, or the OCC index (e.g., the OCC_{id}). In some aspects, the preamble may be mapped to the second RACH resource for the data transmission based on one or more of a frequency resource index for a frequency multiplexed PO, the OCC index (OCC_{id}), the DMRS resource identifier (DMRS_{id}) value, a time resource index for time multiplexed POs, and an index for a configured number of PUSCH slots. For example, referring to FIGS. 5A, 5B, and 8, the UE 804 may select at 818 resources (e.g., a PRU) for a data transmission 820 based on a partitioning and mapping (such as the partitioning described in FIGS. 5A and 5B and/or the mapping described in FIGS. 5A, 5B, and 6B) received in RACH configuration 810.

At 1116, the UE may transmit a data transmission associated with the RACH procedure via the second RACH resource in the set of RACH resources selected based on a mapping of the preamble and at least one of a multiplexing order and an OCC index associated with an OCC applied to the data transmission. For example, 1116 may be performed by application processor(s) 1406, cellular baseband processor(s) 1424, transceiver(s) 1422, antenna(s) 1480, and/or OCC-based RACH component 198 of FIG. 14. In some aspects, the second RACH resource in the set of RACH resources is in a subset of RACH POs associated with the first class of wireless devices. The RACH procedure, in some aspects, may be a four-step RACH procedure and the preamble may be associated with a first message of the four-step RACH procedure and the data transmission may be associated with a third message of the four-step RACH procedure. The second RACH resource, in some aspects, may be associated with a DMRS resource identifier value (e.g., a DMRS_{id}), wherein the DMRS resource identifier value is mapped to at least one of a DMRS port number, a code division multiplexing group number, a sequence number, or the OCC index. In some aspects the first message (e.g., via the preamble transmitted at 1110), or the second message received at 1112, indicates the multiplexing order and a row of an OCC matrix associated with the data transmission. In some aspects, the OCC index may be mapped to a combination of the multiplexing order and the row of the OCC matrix (e.g., as described above in Table 2). For example, referring to FIGS. 5A, 5B, 6B, and 8 the UE 804 may transmit data transmission 820 via a PO and/or PRU selected, determined, and/or identified at 818 based on a mapping as illustrated in FIGS. 5A, 5B, and 6B.

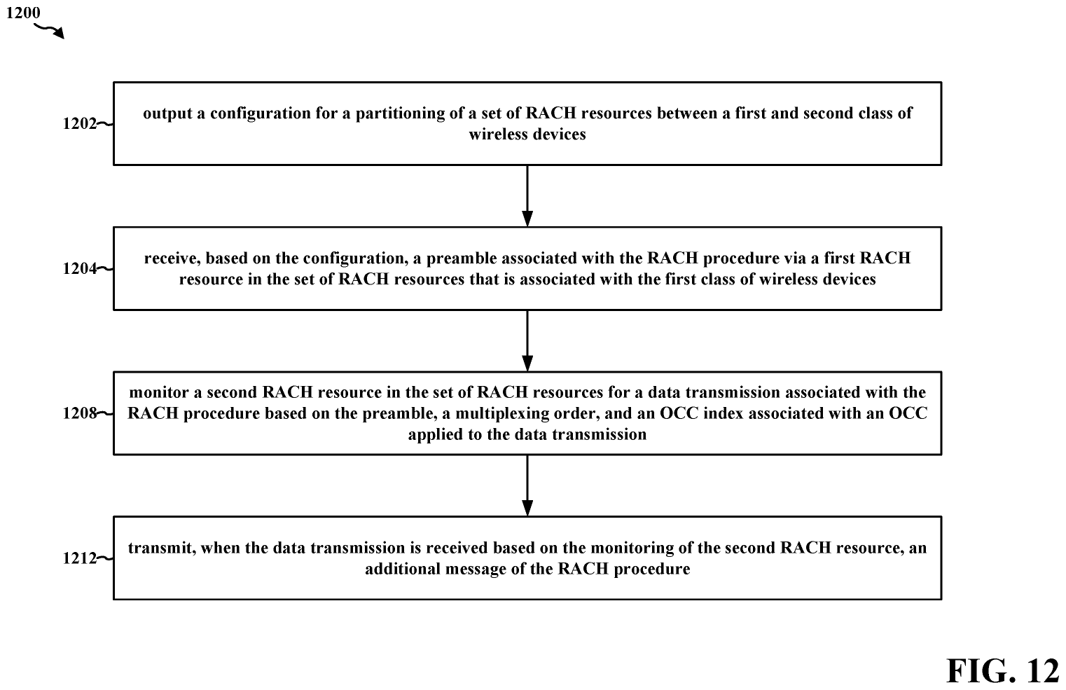

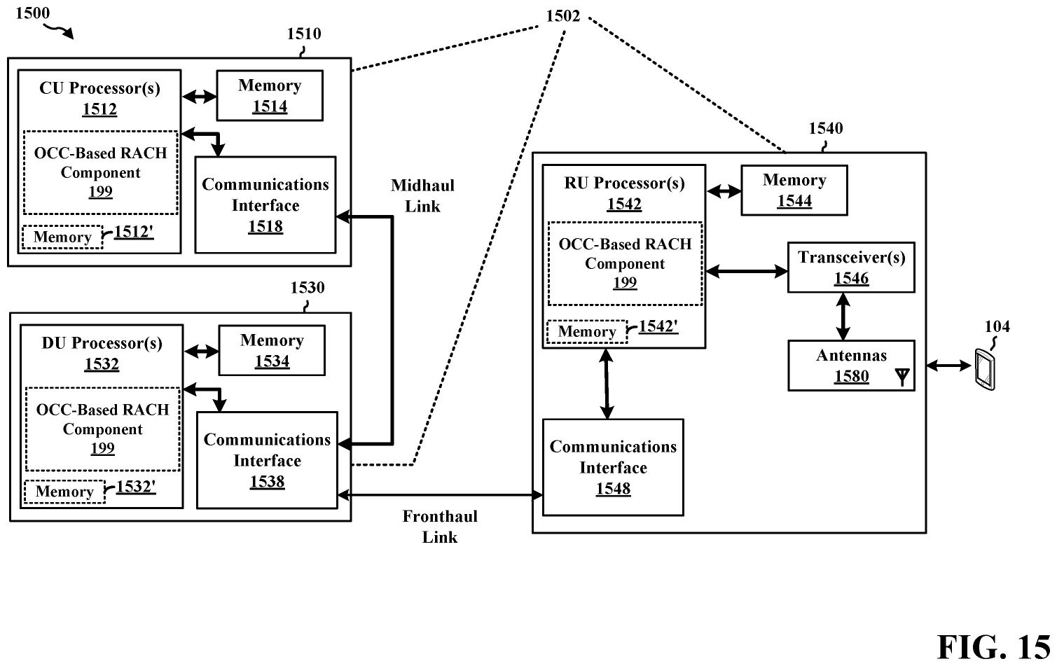

FIG. 12 is a flowchart 1200 of a method of wireless communication. The method may be performed by a network device such as a base station or component thereof (e.g., the base station 102, 702, 802; the network entity 1402, 1502). At 1202, the base station may transmit, to a UE, a configuration for a partitioning of a set of RACH resources between a first class of wireless devices supporting OCC for data transmission during a RACH procedure and a second class of wireless devices not supporting OCC for data transmission. For example, 1202 may be performed by CU processor(s) 1512, DU processor(s) 1532, RU processor(s) 1542, transceiver(s) 1546, antenna(s) 1580, and/or OCC-based RACH component 199 of FIG. 15. In some aspects, the set of RACH resources may include preamble sequences such that a first subset of preambles (e.g., candidate preambles) is associated with the first class of wireless devices and a second (disjoint) subset of preambles is associated with the second class of wireless devices. The set of RACH resources, in some aspects, may include ROs such that a first subset of ROs is associated with the first class of wireless devices and a second (disjoint) subset of ROs is associated with the second class of wireless devices. In some aspects, the configuration for the partitioning of the set of RACH resources may be indicated in one of a SIB (e.g., SIB1) or an RRC message. The configuration, in some aspects, may include (or define) at least a preamble mapping (e.g., a mapping from preamble values to POs or PRUs associated with the use of OCC for data transmissions in a RACH process) based on the preamble is mapped to the second RACH resource for the data transmission based on one or more of a frequency resource index for a frequency multiplexed PO, an OCC index, a DMRS resource identifier value, a time resource index for time multiplexed POs, and an index for a configured number of PUSCH slots. For example, referring to FIGS. 5A, 5B, 6A, 6B, and 8, the base station 802 may transmit RACH configuration 810 indicating a partitioning such as the partitioning illustrated in FIGS. 5A and 5B and/or a preamble mapping as indicated in FIGS. 5A, 5B, 6A, and/or 6B.

At 1204, the base station may receive, based on the configuration, a preamble associated with the RACH procedure via a first RACH resource in the set of RACH resources that is associated with the first class of wireless devices. For example, 1204 may be performed by CU processor(s) 1512, DU processor(s) 1532, RU processor(s) 1542, transceiver(s) 1546, antenna(s) 1580, and/or OCC-based RACH component 199 of FIG. 15. In some aspects, the set of RACH resources includes preamble sequences and the preamble associated with the RACH procedure is selected from a first set of preamble sequences associated with the first class of wireless devices, or the set of RACH resources includes ROs and the first RACH resource is a first RO associated with the first class of wireless devices. In some aspects associated with a 4-step RACH procedure, the preamble may be associated with and/or indicate an OCC index (e.g., a first OCC_{id} associated with a multiplexing order and OCC row index) to be applied to the data (PUSCH) transmission associated with the third message (e.g., a Msg3) of the 4-step RACH procedure. For example, referring to FIG. 8 the base station 802 may receive, preamble transmission 814.

In some aspects associated with a 4-step RACH procedure, the base station may transmit, in a second message of the four-step RACH procedure (e.g., a RAR), an indication of the multiplexing order and the OCC index associated with the OCC applied to the data transmission associated with the third message. In some aspects, the second message may be (or use) an updated RAR format including the additional information regarding the OCC index (e.g., an overriding OCC index) used when the base station has determined not to use the OCC index indicated in the preamble received at 1204. For example, 1206 may be performed by CU processor(s) 1512, DU processor(s) 1532, RU processor(s) 1542, transceiver(s) 1546, antenna(s) 1580, and/or OCC-based RACH component 199 of FIG. 15. If, however, the base station determines to use the OCC index (e.g., the first OCC_{id}) indicated in the preamble received at 1204, the second message of the 4-step RACH procedure may indicate the multiplexing order and the OCC row index associated with the OCC index to be applied to the data transmission associated with the third message by using an unenhanced format (e.g., a standard and/or current format) that does not include an overriding OCC index. For example, referring to FIG. 8 the base station 802 may transmit RAR 816 including an indication of the OCC index or a PO and/or a PRU.

At 1208, the base station may monitor a second RACH resource in the set of RACH resources for a data transmission associated with the RACH procedure based on a mapping of the preamble and at least one of a multiplexing order and an OCC index associated with an OCC applied to the data transmission (e.g., indicated in either of the preamble or the RAR). For example, 1208 may be performed by CU processor(s) 1512, DU processor(s) 1532, RU processor(s) 1542, transceiver(s) 1546, antenna(s) 1580, and/or OCC-based RACH component 199 of FIG. 15. The RACH resource, in some aspects, may be indicated by the second message transmitted at 1206 and/or by a mapping from the preamble received at 1204. In some aspects, the second RACH resource may be associated with a DMRS resource identifier value (e.g., a DMRS_{id}) and the DMRS resource identifier value may be mapped to at least one of a DMRS port number, a code division multiplexing group number, a sequence number, or the OCC index (e.g., the OCC_{id}). In some aspects, the preamble may be mapped to the second RACH resource for the data transmission based on one or more of a frequency resource index for a frequency multiplexed PO, the OCC index (OCC_{id}), the DMRS resource identifier (DMRS_{id}) value, a time resource index for time multiplexed POs, and an index for a configured number of PUSCH slots. For example, referring to FIGS. 5A, 5B, and 8, the base station 802 may monitor at 822 resources (e.g., a PRU) for a data transmission 820 based on a partitioning and mapping (such as the partitioning described in FIGS. 5A and 5B and/or the mapping described in FIGS. 5A, 5B, and 6B) included in RACH configuration 810.

In some aspects, the base station may, based on the monitoring at 1208, receive a data transmission associated with the RACH procedure via the second RACH resource in the set of RACH resources. The second RACH resource, in some aspects, may be selected, determined, and/or identified based on a mapping of the preamble and at least one of a multiplexing order and an OCC index associated with an OCC applied to the data transmission. In some aspects, the second RACH resource in the set of RACH resources is in a subset of RACH POs associated with the first class of wireless devices. The RACH procedure, in some aspects, may be a four-step RACH procedure and the preamble may be associated with a first message of the four-step RACH procedure and the data transmission may be associated with a third message of the four-step RACH procedure. The second RACH resource, in some aspects, may be associated with a DMRS resource identifier value (e.g., a DMRS_{id}), wherein the DMRS resource identifier value is mapped to at least one of a DMRS port number, a code division multiplexing group number, a sequence number, or the OCC index. In some aspects the first message (e.g., via the preamble received at 1204), or the second message transmitted at 1206, indicates the multiplexing order and a row of an OCC matrix associated with the data transmission. In some aspects, the OCC index may be mapped to a combination of the multiplexing order and the row of the OCC matrix (e.g., as described above in Table 2). For example, referring to FIGS. 5A, 5B, 6B, and 8 the base station 802 may receive data transmission 820 via a PO and/or PRU selected, determined, and/or identified based on a mapping as illustrated in FIGS. 5A, 5B, and 6B.

At 1212 the base station may transmit, when the data transmission is received based on the monitoring of the second RACH resource, an additional message of the RACH procedure. For example, 1212 may be performed by CU processor(s) 1512, DU processor(s) 1532, RU processor(s) 1542, transceiver(s) 1546, antenna(s) 1580, and/or OCC-based RACH component 199 of FIG. 15. In some aspects, the base station may transmit the additional message of the RACH procedure to the UE. For example, referring to FIG. 8 the base station 802 may transmit RACH response 824 based on receiving data transmission 820.

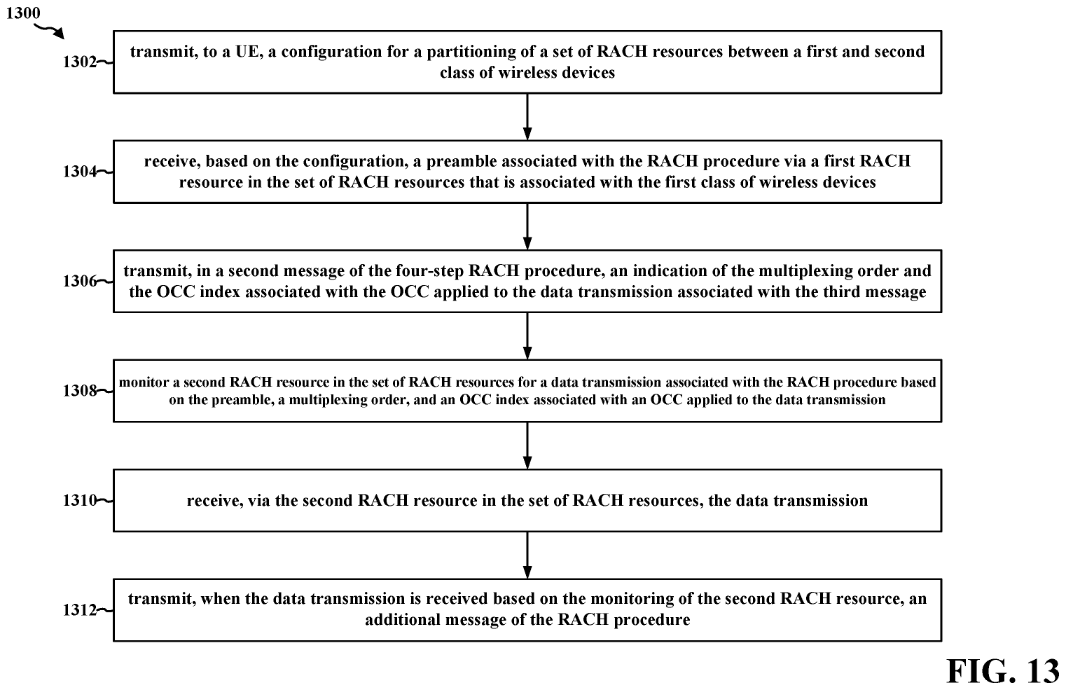

FIG. 13 is a flowchart 1300 of a method of wireless communication. The method may be performed by a network device such as a base station or component thereof (e.g., the base station 102, 702, 802; the network entity 1402, 1502). At 1302, the base station may transmit, to a UE, a configuration for a partitioning of a set of RACH resources between a first class of wireless devices supporting OCC for data transmission during a RACH procedure and a second class of wireless devices not supporting OCC for data transmission. For example, 1302 may be performed by CU processor(s) 1512, DU processor(s) 1532, RU processor(s) 1542, transceiver(s) 1546, antenna(s) 1580, and/or OCC-based RACH component 199 of FIG. 15. In some aspects, the set of RACH resources may include preamble sequences such that a first subset of preambles (e.g., candidate preambles) is associated with the first class of wireless devices and a second (disjoint) subset of preambles is associated with the second class of wireless devices. The set of RACH resources, in some aspects, may include ROs such that a first subset of ROs is associated with the first class of wireless devices and a second (disjoint) subset of ROs is associated with the second class of wireless devices. In some aspects, the configuration for the partitioning of the set of RACH resources may be indicated in one of a SIB (e.g., SIB1) or an RRC message. The configuration, in some aspects, may include (or define) at least a preamble mapping (e.g., a mapping from preamble values to POs or PRUs associated with the use of OCC for data transmissions in a RACH process) based on the preamble is mapped to the second RACH resource for the data transmission based on one or more of a frequency resource index for a frequency multiplexed PO, an OCC index, a DMRS resource identifier value, a time resource index for time multiplexed POs, and an index for a configured number of PUSCH slots. For example, referring to FIGS. 5A, 5B, 6A, 6B, and 8, the base station 802 may transmit RACH configuration 810 indicating a partitioning such as the partitioning illustrated in FIGS. 5A and 5B and/or a preamble mapping as indicated in FIGS. 5A, 5B, 6A, and/or 6B.

At 1304, the base station may receive, based on the configuration, a preamble associated with the RACH procedure via a first RACH resource in the set of RACH resources that is associated with the first class of wireless devices. For example, 1304 may be performed by CU processor(s) 1512, DU processor(s) 1532, RU processor(s) 1542, transceiver(s) 1546, antenna(s) 1580, and/or OCC-based RACH component 199 of FIG. 15. In some aspects, the set of RACH resources includes preamble sequences and the preamble associated with the RACH procedure is selected from a first set of preamble sequences associated with the first class of wireless devices, or the set of RACH resources includes ROs and the first RACH resource is a first RO associated with the first class of wireless devices. In some aspects associated with a 4-step RACH procedure, the preamble may be associated with and/or indicate an OCC index (e.g., a first OCC_{id} associated with a multiplexing order and OCC row index) to be applied to the data (PUSCH) transmission associated with the third message (e.g., a Msg3) of the 4-step RACH procedure. For example, referring to FIG. 8 the base station 802 may receive, preamble transmission 814.

At 1306, the base station may transmit, in a second message of the four-step RACH procedure (e.g., a RAR), an indication of the multiplexing order and the OCC index associated with the OCC applied to the data transmission associated with the third message. In some aspects, the second message may be an updated RAR format including the additional information regarding the OCC index (e.g., an overriding OCC index) used when the base station has determined not to use the OCC index indicated in the preamble received at 1304. For example, 1306 may be performed by CU processor(s) 1512, DU processor(s) 1532, RU processor(s) 1542, transceiver(s) 1546, antenna(s) 1580, and/or OCC-based RACH component 199 of FIG. 15. If, however, the base station determines to use the OCC index (e.g., the first OCC_{id}) indicated in the preamble received at 1304, the second message of the 4-step RACH procedure may indicate the multiplexing order and the OCC row index associated with the OCC index to be applied to the data transmission associated with the third message by using an unenhanced format (e.g., a standard and/or current format) that does not include an overriding OCC index. For example, referring to FIG. 8 the base station 802 may transmit RAR 816 including an indication of the OCC index or a PO and/or a PRU.

At 1308, the base station may monitor a second RACH resource in the set of RACH resources for a data transmission associated with the RACH procedure based on a mapping of the preamble and at least one of a multiplexing order and an OCC index associated with an OCC applied to the data transmission (e.g., indicated in either of the preamble or the RAR). For example, 1308 may be performed by CU processor(s) 1512, DU processor(s) 1532, RU processor(s) 1542, transceiver(s) 1546, antenna(s) 1580, and/or OCC-based RACH component 199 of FIG. 15. The RACH resource, in some aspects, may be indicated by the second message transmitted at 1306 and/or by a mapping from the preamble received at 1304. In some aspects, the second RACH resource may be associated with a DMRS resource identifier value (e.g., a DMRS_{id}) and the DMRS resource identifier value may be mapped to at least one of a DMRS port number, a code division multiplexing group number, a sequence number, or the OCC index (e.g., the OCC_{id}). In some aspects, the preamble may be mapped to the second RACH resource for the data transmission based on one or more of a frequency resource index for a frequency multiplexed PO, the OCC index (OCC_{id}), the DMRS resource identifier (DMRS_{id}) value, a time resource index for time multiplexed POs, and an index for a configured number of PUSCH slots. For example, referring to FIGS. 5A, 5B, and 8, the base station 802 may monitor at 822 resources (e.g., a PRU) for a data transmission 820 based on a partitioning and mapping (such as the partitioning described in FIGS. 5A and 5B and/or the mapping described in FIGS. 5A, 5B, and 6B) included in RACH configuration 810.

At 1310, the base station may receive a data transmission associated with the RACH procedure via the second RACH resource in the set of RACH resources. The second RACH resource, in some aspects, may be selected, determined, and/or identified based on a mapping of the preamble and at least one of a multiplexing order and an OCC index associated with an OCC applied to the data transmission. For example, 1310 may be performed by CU processor(s) 1512, DU processor(s) 1532, RU processor(s) 1542, transceiver(s) 1546, antenna(s) 1580, and/or OCC-based RACH component 199 of FIG. 15. In some aspects, the second RACH resource in the set of RACH resources is in a subset of RACH POs associated with the first class of wireless devices. The RACH procedure, in some aspects, may be a four-step RACH procedure and the preamble may be associated with a first message of the four-step RACH procedure and the data transmission may be associated with a third message of the four-step RACH procedure. The second RACH resource, in some aspects, may be associated with a DMRS resource identifier value (e.g., a DMRS_{id}), wherein the DMRS resource identifier value is mapped to at least one of a DMRS port number, a code division multiplexing group number, a sequence number, or the OCC index. In some aspects the first message (e.g., via the preamble received at 1304), or the second message transmitted at 1306, indicates the multiplexing order and a row of an OCC matrix associated with the data transmission. In some aspects, the OCC index may be mapped to a combination of the multiplexing order and the row of the OCC matrix (e.g., as described above in Table 2). For example, referring to FIGS. 5A, 5B, 6B, and 8 the base station 802 may receive data transmission 820 via a PO and/or PRU selected, determined, and/or identified based on a mapping as illustrated in FIGS. 5A, 5B, and 6B.

At 1312 the base station may transmit, when the data transmission is received based on the monitoring of the second RACH resource, an additional message of the RACH procedure. For example, 1312 may be performed by CU processor(s) 1512, DU processor(s) 1532, RU processor(s) 1542, transceiver(s) 1546, antenna(s) 1580, and/or OCC-based RACH component 199 of FIG. 15. In some aspects, the base station may transmit the additional message of the RACH procedure to the UE. For example, referring to FIG. 8 the base station 802 may transmit RACH response 824 based on receiving data transmission 820.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize one or more antennas 1480 for communication. The cellular baseband processor(s) 1424 communicates through the transceiver(s) 1422 via the one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the OCC-based RACH component 198 may be configured to configured to receive a configuration for a partitioning of a set of RACH resources between a first class of wireless devices supporting OCC for data transmission during a RACH procedure and a second class of wireless devices not supporting OCC for data transmission, transmit, based on the configuration, a preamble associated with the RACH procedure via a first RACH resource in the set of RACH resources that is associated with the first class of wireless devices, and transmit a data transmission associated with the RACH procedure via a second RACH resource in the set of RACH resources selected based on a mapping of the preamble and at least one of a multiplexing order and an OCC index associated with an OCC applied to the data transmission. The OCC-based RACH component 198 may be within the cellular baseband processor(s) 1424, the application processor(s) 1406, or both the cellular baseband processor(s) 1424 and the application processor(s) 1406. The OCC-based RACH component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for receiving a configuration for a partitioning of a set of RACH resources between a first class of wireless devices supporting OCC for data transmission during a RACH procedure and a second class of wireless devices not supporting OCC for data transmission. The apparatus 1404, and in particular the cellular baseband processor(s) 1424 and/or the application processor(s) 1406, may include means for transmitting, based on the configuration, a preamble associated with the RACH procedure via a first RACH resource in the set of RACH resources that is associated with the first class of wireless devices. The apparatus 1404, and in particular the cellular baseband processor(s) 1424 and/or the application processor(s) 1406, may include means for transmitting a data transmission associated with the RACH procedure via a second RACH resource in the set of RACH resources selected based on a mapping of the preamble and at least one of a multiplexing order and an OCC index associated with an OCC applied to the data transmission. The apparatus 1404, and in particular the cellular baseband processor(s) 1424 and/or the application processor(s) 1406, may include means for determining that the wireless device belongs to the first class of wireless devices. The apparatus 1404, and in particular the cellular baseband processor(s) 1424 and/or the application processor(s) 1406, may include means for selecting the preamble based on the determination that the wireless device belongs to the first class of wireless devices. The apparatus 1404, and in particular the cellular baseband processor(s) 1424 and/or the application processor(s) 1406, may include means for receiving, in a second message of the four-step RACH procedure, an indication of the multiplexing order and the OCC index associated with the OCC applied to the data transmission associated with the third message. The apparatus 1404, and in particular the cellular baseband processor(s) 1424 and/or the application processor(s) 1406, may include means for transmitting, based on the configuration, an additional preamble associated with the RACH procedure via a third RACH resource associated with the second class of wireless devices. The apparatus 1404, and in particular the cellular baseband processor(s) 1424 and/or the application processor(s) 1406, may include means for transmitting, via a fourth RACH resource selected based on a mapping of the preamble, an additional data transmission associated with the RACH procedure. The apparatus 1404 may further include means for performing any of the aspects described in connection with the flowcharts in FIGS. 9-11, and/or performed by the UE in the communication flow of FIGS. 7 and 8. The means may be the OCC-based RACH component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the OCC-based RACH component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, one or more antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the OCC-based RACH component 199 may be configured to transmit, to a UE, a configuration for a partitioning of a set of RACH resources between a first class of wireless devices supporting OCC for data transmission during a RACH procedure and a second class of wireless devices not supporting OCC for data transmission during the RACH procedure. The OCC-based RACH component 199 may be configured to receive, based on the configuration, a preamble associated with the RACH procedure via a first RACH resource in the set of RACH resources that is associated with the first class of wireless devices, monitor a second RACH resource in the set of RACH resources for a data transmission associated with the RACH procedure based on the preamble, a multiplexing order, and an OCC index associated with an OCC applied to the data transmission, and transmit, when the data transmission is received based on the monitoring of the second RACH resource, an additional message of the RACH procedure. The OCC-based RACH component 199 may be within one or more processors of one or more of the CU 1510, DU 1530, and the RU 1540. The OCC-based RACH component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for transmitting, to a user equipment (UE), a configuration for a partitioning of a set of random access channel (RACH) resources between a first class of wireless devices supporting orthogonal cover codes (OCC) for data transmission during a RACH procedure and a second class of wireless devices not supporting OCC for data transmission during the RACH procedure. The network entity 1502, in some aspects, may include means for receiving, based on the configuration, a preamble associated with the RACH procedure via a first RACH resource in the set of RACH resources that is associated with the first class of wireless devices. The network entity 1502, in some aspects, may include means for monitoring a second RACH resource in the set of RACH resources for a data transmission associated with the RACH procedure based on the preamble, a multiplexing order, and an OCC index associated with an OCC applied to the data transmission. The network entity 1502, in some aspects, may include means for transmitting, when the data transmission is received based on the monitoring of the second RACH resource, an additional message of the RACH procedure. The network entity 1502, in some aspects, may include means for transmitting, in a second message of the four-step RACH procedure, an indication of the multiplexing order and the OCC index associated with the OCC applied to the data transmission associated with the third message. The network entity 1502 may further include means for performing any of the aspects described in connection with the flowcharts in FIGS. 12 and 13, and/or performed by the base station in the communication flow of FIGS. 7 and 8. The means may be the OCC-based RACH component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIGS. 7, 8, 12, and 13.

Various aspects relate generally to approaches for using OCC in association with a RACH process. Some aspects more specifically relate to approaches for preamble partitioning based on OCC for one or more of a 2-step RACH process or a 4-step RACH process, and a preamble to physical uplink shared channel (PUSCH) mapping for a RACH message (e.g., a MsgA or a Msg3) with OCC. In some examples, a network device may be configured to transmit, to a UE, a configuration for a partitioning of a set of RACH resources between a first class of wireless devices supporting OCC for data transmission during a RACH procedure and a second class of wireless devices not supporting OCC for data transmission during the RACH procedure. The network device may be configured to receive, based on the configuration, a preamble associated with the RACH procedure via a first RACH resource in the set of RACH resources that is associated with the first class of wireless devices, monitor a second RACH resource in the set of RACH resources for a data transmission associated with the RACH procedure based on the preamble, a multiplexing order, and an OCC index associated with an OCC applied to the data transmission, and transmit, when the data transmission is received based on the monitoring of the second RACH resource, an additional message of the RACH procedure. In an aspect of the disclosure, a method, a computer-readable medium, and an apparatus are provided. In some examples, a wireless device may be configured to receive a configuration for a partitioning of a set of RACH resources between a first class of wireless devices supporting OCC for data transmission during a RACH procedure and a second class of wireless devices not supporting OCC for data transmission, transmit, based on the configuration, a preamble associated with the RACH procedure via a first RACH resource in the set of RACH resources that is associated with the first class of wireless devices, and transmit a data transmission associated with the RACH procedure via a second RACH resource in the set of RACH resources selected based on a mapping of the preamble and at least one of a multiplexing order and an OCC index associated with an OCC applied to the data transmission.

Particular aspects of the subject matter described in this disclosure can be implemented to realize one or more of the following potential advantages. In some examples, by preamble partitioning based on OCC for a RACH process, the described techniques can be used to improve the efficiency of a RACH process (e.g., reducing collisions for the RACH process).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network device, comprising: transmitting, to a user equipment (UE), a configuration for a partitioning of a set of random access channel (RACH) resources between a first class of wireless devices supporting orthogonal cover codes (OCC) for data transmission during a RACH procedure and a second class of wireless devices not supporting OCC for data transmission during the RACH procedure; receiving, based on the configuration, a preamble associated with the RACH procedure via a first RACH resource in the set of RACH resources that is associated with the first class of wireless devices; monitoring a second RACH resource in the set of RACH resources for a data transmission associated with the RACH procedure based on the preamble, a multiplexing order, and an OCC index associated with an OCC applied to the data transmission; and transmitting, when the data transmission is received based on the monitoring of the second RACH resource, an additional message of the RACH procedure.

Aspect 2 is the method of aspect 1, wherein: the set of RACH resources includes preamble sequences and the preamble associated with the RACH procedure is selected from a first set of preamble sequences associated with the first class of wireless devices; or the set of RACH resources includes RACH occasions (ROs) and the first RACH resource is a first RO associated with the first class of wireless devices.

Aspect 3 is the method of any of aspects 1 and 2, wherein the configuration for the partitioning of the set of RACH resources is indicated in one of a system information block (SIB) or a radio resource control (RRC) message.

Aspect 4 is the method of any of aspects 1 to 3, wherein the second RACH resource is in a subset of RACH physical uplink shared channel (PUSCH) occasions (POs) associated with the first class of wireless devices.

Aspect 5 is the method of any of aspects 1 to 4, wherein the RACH procedure is a two-step RACH procedure and the preamble and the data transmission are associated with a first message of a first step of the two-step RACH procedure, wherein the first message indicates the multiplexing order and a row of an OCC matrix associated with the data transmission, and wherein the OCC index is mapped to a combination of the multiplexing order and the row of the OCC matrix.

Aspect 6 is the method of aspect 5, wherein the second RACH resource is associated with a demodulation reference signal (DMRS) resource identifier value, wherein the DMRS resource identifier value is mapped to at least one of a DMRS port number, a code division multiplexing group number, a sequence number, or the OCC index.

Aspect 7 is the method of aspect 6, wherein the preamble is mapped to the second RACH resource for the data transmission based on one or more of: a frequency resource index for a frequency multiplexed PO; the OCC index; the DMRS resource identifier value; a time resource index for time multiplexed POs; and an index for a configured number of PUSCH slots.

Aspect 8 is the method of any of aspects 1 to 4, wherein the RACH procedure is a four-step RACH procedure and the preamble is associated with a first message of the four-step RACH procedure and the data transmission is associated with a third message of the four-step RACH procedure.

Aspect 9 is the method of aspect 8, further comprising: transmitting, in a second message of the four-step RACH procedure, an indication of the multiplexing order and the OCC index associated with the OCC applied to the data transmission associated with the third message.

Aspect 10 is a method of wireless communication at a wireless device, comprising: receiving a configuration for a partitioning of a set of random access channel (RACH) resources between a first class of wireless devices supporting orthogonal cover codes (OCC) for data transmission during a RACH procedure and a second class of wireless devices not supporting OCC for data transmission; transmitting, based on the configuration, a preamble associated with the RACH procedure via a first RACH resource in the set of RACH resources that is associated with the first class of wireless devices; and transmitting a data transmission associated with the RACH procedure via a second RACH resource in the set of RACH resources selected based on a mapping of the preamble and at least one of a multiplexing order and an OCC index associated with an OCC applied to the data transmission.

Aspect 11 is the method of aspect 10, further comprising: determining that the wireless device belongs to the first class of wireless devices; and selecting the preamble based on the determination that the wireless device belongs to the first class of wireless devices.

Aspect 12 is the method of any of aspects 10 and 11, wherein: the set of RACH resources includes preamble sequences and the preamble associated with the RACH procedure is selected from a first set of preamble sequences associated with the first class of wireless devices; or the set of RACH resources includes RACH occasions (ROs) and the first RACH resource is a first RO associated with the first class of wireless devices.

Aspect 13 is the method of any of aspects 10 to 13, wherein the configuration for the partitioning of the set of RACH resources is indicated in one of a system information block (SIB) or a radio resource control (RRC) message.

Aspect 14 is the method of any of aspects 10 to 13, wherein the second RACH resource in the set of RACH resources is in a subset of RACH physical uplink shared channel (PUSCH) occasions (POs) associated with the first class of wireless devices.

Aspect 15 is the method of any of aspects 10 to 14, wherein the RACH procedure is a two-step RACH procedure and the preamble and the data transmission are associated with a first message of a first step of the two-step RACH procedure, wherein the first message indicates the multiplexing order and a row of an OCC matrix associated with the data transmission, and wherein the OCC index is mapped to a combination of the multiplexing order and the row of the OCC matrix.

Aspect 16 is the method of aspect 15, wherein the second RACH resource is associated with a demodulation reference signal (DMRS) resource identifier value, wherein the DMRS resource identifier value is mapped to at least one of a DMRS port number, a code division multiplexing group number, a sequence number, or the OCC index.

Aspect 17 is the method of aspect 16, wherein the preamble is mapped to the second RACH resource for the data transmission based on one or more of: a frequency resource index for a frequency multiplexed PO; the OCC index; the DMRS resource identifier value; a time resource index for time multiplexed POs; and an index for a configured number of PUSCH slots.

Aspect 18 is the method of any of aspects 10 to 14, wherein the RACH procedure is a four-step RACH procedure and the preamble is associated with a first message of the four-step RACH procedure and the data transmission is associated with a third message of the four-step RACH procedure.

Aspect 19 is the method of aspect 18, further comprising: receiving, in a second message of the four-step RACH procedure, an indication of the multiplexing order and the OCC index associated with the OCC applied to the data transmission associated with the third message.

Aspect 20 is the method of any of aspects 10 to 19, wherein after a threshold number of failures of the RACH procedure using the RACH resources associated with the first class of wireless devices, the method further comprises: transmitting, based on the configuration, an additional preamble associated with the RACH procedure via a third RACH resource associated with the second class of wireless devices; and transmitting, via a fourth RACH resource selected based on a mapping of the preamble, an additional data transmission associated with the RACH procedure.

Aspect 21 is an apparatus for wireless communication at a device including a memory and at least one processor coupled to the memory and, based at least in part on information stored in the memory, the at least one processor is configured to implement any of aspects 1 to 9.

Aspect 22 is the apparatus of aspect 21, further including a transceiver or an antenna coupled to the at least one processor.

Aspect 23 is an apparatus for wireless communication at a device including means for implementing any of aspects 1 to 9.

Aspect 24 is a computer-readable medium (e.g., a non-transitory computer-readable medium) storing computer executable code, where the code when executed by a processor causes the processor to implement any of aspects 1 to 9.

Aspect 25 is an apparatus for wireless communication at a device including a memory and at least one processor coupled to the memory and, based at least in part on information stored in the memory, the at least one processor is configured to implement any of aspects 10 to 20.

Aspect 26 is the apparatus of aspect 25, further including a transceiver or an antenna coupled to the at least one processor.

Aspect 27 is an apparatus for wireless communication at a device including means for implementing any of aspects 10 to 20.

Aspect 28 is a computer-readable medium (e.g., a non-transitory computer-readable medium) storing computer executable code, where the code when executed by a processor causes the processor to implement any of aspects 10 to 20.

What is claimed is:

1. An apparatus for wireless communication at a network device, comprising:
at least one memory; and
at least one processor coupled to the at least one memory and, based at least in part on stored information that is stored in the at least one memory, the at least one processor, individually or in any combination, is configured to:
transmit, to a user equipment (UE), a configuration for a partitioning of a set of random access channel (RACH) resources between a first class of wireless devices supporting orthogonal cover codes (OCC) for data transmission during a RACH procedure and a second class of wireless devices not supporting the OCC for data transmission during the RACH procedure;
receive, based on the configuration, a preamble associated with the RACH procedure via a first RACH resource in the set of RACH resources that is associated with the first class of wireless devices;
monitor a second RACH resource in the set of RACH resources for a data transmission associated with the RACH procedure based on the preamble, a multiplexing order, and an OCC index associated with the OCC applied to the data transmission; and
transmit, when the data transmission is received based on the monitoring of the second RACH resource, an additional message of the RACH procedure.

2. The apparatus of claim 1, wherein:
the set of RACH resources includes preamble sequences and the preamble associated with the RACH procedure is selected from a first set of preamble sequences associated with the first class of wireless devices; or
the set of RACH resources includes RACH occasions (ROs) and the first RACH resource is a first RO associated with the first class of wireless devices.

3. The apparatus of claim 1, wherein the configuration for the partitioning of the set of RACH resources is indicated in one of a system information block (SIB) or a radio resource control (RRC) message.

4. The apparatus of claim 1, wherein the second RACH resource is in a subset of RACH physical uplink shared channel (PUSCH) occasions (POs) associated with the first class of wireless devices.

5. The apparatus of claim 1, wherein the RACH procedure is a two-step RACH procedure and the preamble and the data transmission are associated with a first message of a first step of the two-step RACH procedure, wherein the first message indicates the multiplexing order and a row of an OCC matrix associated with the data transmission, and wherein the OCC index is mapped to a combination of the multiplexing order and the row of the OCC matrix.

6. The apparatus of claim 5, wherein the second RACH resource is associated with a demodulation reference signal (DMRS) resource identifier value, wherein the DMRS resource identifier value is mapped to at least one of a DMRS port number, a code division multiplexing group number, a sequence number, or the OCC index.

7. The apparatus of claim 6, wherein the preamble is mapped to the second RACH resource for the data transmission based on one or more of:
a frequency resource index for a frequency multiplexed PO;
the OCC index;
the DMRS resource identifier value;
a time resource index for time multiplexed POs; and
an index for a configured number of PUSCH slots.

8. The apparatus of claim 1, wherein the RACH procedure is a four-step RACH procedure and the preamble is associated with a first message of the four-step RACH procedure and the data transmission is associated with a third message of the four-step RACH procedure.

9. The apparatus of claim 8, further comprising a transceiver coupled to the at least one processor, wherein the at least one processor, individually or in any combination, is further configured to:
transmit, to the UE via the transceiver in a second message of the four-step RACH procedure, an indication of the multiplexing order and the OCC index associated with the OCC applied to the data transmission associated with the third message.

10. An apparatus for wireless communication at a wireless device, comprising:
at least one memory; and
at least one processor coupled to the at least one memory and, based at least in part on stored information that is stored in the at least one memory, the at least one processor, individually or in any combination, is configured to:
receive a configuration for a partitioning of a set of random access channel (RACH) resources between a first class of wireless devices supporting orthogonal cover codes (OCC) for data transmission during a RACH procedure and a second class of wireless devices not supporting the OCC for data transmission;
transmit, based on the configuration, a preamble associated with the RACH procedure via a first RACH resource in the set of RACH resources that is associated with the first class of wireless devices; and
transmit a data transmission associated with the RACH procedure via a second RACH resource in the set of RACH resources selected based on a mapping of the preamble and at least one of a multiplexing order and an OCC index associated with the OCC applied to the data transmission.

11. The apparatus of claim 10, wherein the at least one processor, individually or in any combination, is further configured to:
determine that the wireless device belongs to the first class of wireless devices; and
select the preamble based on the determination that the wireless device belongs to the first class of wireless devices.

12. The apparatus of claim 10, wherein:
the set of RACH resources includes preamble sequences and the preamble associated with the RACH procedure is selected from a first set of preamble sequences associated with the first class of wireless devices; or
the set of RACH resources includes RACH occasions (ROs) and the first RACH resource is a first RO associated with the first class of wireless devices.

13. The apparatus of claim 10, wherein the configuration for the partitioning of the set of RACH resources is indicated in one of a system information block (SIB) or a radio resource control (RRC) message.

14. The apparatus of claim 10, wherein the second RACH resource in the set of RACH resources is in a subset of RACH physical uplink shared channel (PUSCH) occasions (POs) associated with the first class of wireless devices.

15. The apparatus of claim 10, wherein the RACH procedure is a two-step RACH procedure and the preamble and the data transmission are associated with a first message of a first step of the two-step RACH procedure, wherein the first message indicates the multiplexing order and a row of an OCC matrix associated with the data transmission, and wherein the OCC index is mapped to a combination of the multiplexing order and the row of the OCC matrix.

16. The apparatus of claim 15, wherein the second RACH resource is associated with a demodulation reference signal (DMRS) resource identifier value, wherein the DMRS resource identifier value is mapped to at least one of a DMRS port number, a code division multiplexing group number, a sequence number, or the OCC index.

17. The apparatus of claim 16, wherein the preamble is mapped to the second RACH resource for the data transmission based on one or more of:
a frequency resource index for a frequency multiplexed PO;
the OCC index;
the DMRS resource identifier value;
a time resource index for time multiplexed POs; and
an index for a configured number of PUSCH slots.

18. The apparatus of claim 10, wherein the RACH procedure is a four-step RACH procedure and the preamble is associated with a first message of the four-step RACH procedure and the data transmission is associated with a third message of the four-step RACH procedure, wherein the preamble is mapped to a first multiplexing order and a first OCC row index, and wherein the at least one processor, individually or in any combination, is further configured to:
receive, in a second message of the four-step RACH procedure, an indication of one of the first multiplexing order and the first OCC row index or a second multiplexing order and a second OCC row index associated with the OCC applied to the data transmission associated with the third message.

19. The apparatus of claim 10, wherein, after a threshold number of failures of the RACH procedure using the RACH resources associated with the first class of wireless devices, the at least one processor, individually or in any combination, is further configured to:
transmit, based on the configuration, an additional preamble associated with the RACH procedure via a third RACH resource associated with the second class of wireless devices; and
transmit, via a fourth RACH resource selected based on an additional mapping of the preamble, an additional data transmission associated with the RACH procedure.

20. A method of wireless communication at a wireless device, comprising:
receiving a configuration for a partitioning of a set of random access channel (RACH) resources between a first class of wireless devices supporting orthogonal cover codes (OCC) for data transmission during a RACH procedure and a second class of wireless devices not supporting the OCC for data transmission;
transmitting, based on the configuration, a preamble associated with the RACH procedure via a first RACH resource in the set of RACH resources that is associated with the first class of wireless devices; and
transmitting a data transmission associated with the RACH procedure via a second RACH resource in the set of RACH resources selected based on a mapping of the preamble and at least one of a multiplexing order and an OCC index associated with the OCC applied to the data transmission.
